(19) United States
(12) Patent Application Publication
(10) Pub. No.: US 2017/0056970 A1
(43) Pub. Date: Mar. 2, 2017

(54) CONTROL OF A THREE-DIMENSIONAL PRINTING PROCESS USING ESTIMATED THERMAL PARAMETERS

(71) Applicant: Desktop Metal, Inc., Lexington, MA (US)

(72) Inventors: Ricardo Chin, Shrewsbury, MA (US); Ric Fulop, Lexington, MA (US); Jonah Samuel Myerberg, Lexington, MA (US); Yet Ming-Chiang, Weston, MA (US)

(21) Appl. No.: 15/245,836

(22) Filed: Aug. 24, 2016

Related U.S. Application Data
(60) Provisional application No. 62/208,883, filed on Aug. 24, 2015.
(60) Provisional application No. 62/212,244, filed on Aug. 31, 2015.

(51) Int. Cl. B22D 23/00; B33Y 30/00; B22D 37/00; B33Y 70/00; B22D 39/00; B33Y 10/00; B33Y 50/02

(52) U.S. Cl. CPC B22D 23/003; B33Y 10/00; B33Y 30/00; B33Y 50/02; B33Y 70/00; B22D 39/00; B22D 37/00

(57) ABSTRACT

Thermal parameters for an additive manufacturing process are estimated using computer modeling, and these thermal parameters are used to control the additive manufacturing process. For example, the thermal parameters may be estimated based on bulk material properties, object geometry, control signals to thermal components of a system, and so forth.

### CROSS-REFERENCE TO RELATED APPLICATIONS

This application claims the benefit of U.S. Provisional Patent Application No. 62/208,883 filed on Aug. 24, 2015 and U.S. Provisional Patent Application No. 62/212,244 filed on Aug. 31, 2015, where the entire content of each is hereby incorporated by reference.

### TECHNICAL FIELD

The present disclosure generally relates to additive manufacturing, and more specifically to the three-dimensional printing of metal objects.

### BACKGROUND

Fused filament fabrication and the like are techniques for fabricating three-dimensional objects from a thermoplastic or similar material. Machines using this technique can fabricate three-dimensional objects additively by depositing lines of material in layers. While these polymer-based techniques have been changed and improved over the years, the physical principles applicable to polymer-based systems may not be applicable to metal-based systems, which tend to pose different challenges. There remains a need for three-dimensional printing techniques suitable for metal additive manufacturing.

### SUMMARY

An additive manufacturing system uses electrohydrodynamic (EHD) printing techniques to form a metallic object based upon a digital model. A metal build material is melted within a reservoir and expelled through an outlet of an expeller in a controlled manner using EHD force to modulate surface tension on a meniscus of the liquid metal at the outlet of the expeller. Concurrently, a positioning robotics system moves the expeller relative to a print bed along a toolpath that forms the solidifying metal droplets into a net shape according to the digital model.

In an aspect, an additive manufacturing system may include a build chamber and an expeller. The expeller may include a reservoir, a heater configured to maintain a metal within the reservoir in a liquid form, and an outlet within the build chamber, where the expeller is configured to modulate a release of the metal in the liquid form from the outlet by applying an electrohydrodynamic force to control a surface tension on the metal at the outlet, thereby providing a supply of build material. The additive manufacturing system may also include a print bed within the build chamber, the print bed including a surface configured to receive the supply of build material, a robotic positioning assembly structurally configured to position the outlet relative to the print bed within the build chamber, and a controller coupled to the expeller and the robotic positioning assembly, the controller operable to control the additive manufacturing system to fabricate an object based on a digital model that provides a three-dimensional representation of the object.

Implementations may include one or more of the following features. The expeller may include an electrohydrodynamic (EHD) device including one or more electrodes in communication with the outlet, where one or more of a voltage difference or a capacitance between the metal and the one or more electrodes is configured to create an electrostatic field for modulating the surface tension of the metal in the liquid form sufficient to expel a droplet of the metal in the liquid form from the outlet. The additive manufacturing system may further include a second expeller configured to modulate a release of a second material in a liquid form from a second outlet of the second expeller, thereby providing a supply of a second build material. The second material may include a support material, where the second expeller is configured to deposit the support material for fabrication of a support for the object. The second material may include a metal, the second expeller including an electrohydrodynamic (EHD) device including one or more electrodes in communication with the second outlet, where one or more of a voltage difference or a capacitance between the metal and the one or more electrodes is configured to create an electrostatic field for modulating a surface tension of the metal in a liquid form within the second outlet sufficient to expel a droplet of the metal in the liquid form from the second outlet. The second material may include one or more of a metal, a wax, a polymer, and a salt. The build chamber may be is environmentally sealed. The additive manufacturing system may further include a deoxygenator in communication with the build chamber for removing oxygen from the build chamber. The deoxygenator may include one or more of an oxygen filter, an oxygen getter, an electrochemical oxygen pump, and a cover gas. The heater may include an induction coil. The release of the metal in the liquid form from the outlet may be modulated by an inductor configured to control a magnetic field around the outlet. The additive manufacturing system may further include a sensor in communication with the controller, the sensor configured to detect progress of fabrication of the object, the controller configured to adjust at least one parameter of the additive manufacturing system in response to the detected progress of fabrication of the object. The additive manufacturing system may further include a sensor in communication with the controller, the sensor configured to monitor one or more of the surface tension and a meniscus of the metal in the liquid form, the controller configured to adjust at least one parameter of the additive manufacturing system to control one or more of the surface tension and the meniscus. The controller may be configured to apply a voltage to the metal in the liquid form to control one or more of the surface tension and the meniscus. The at least one parameter may include a temperature of one or more of the metal in the liquid form, at least a portion of a volume of the build chamber, and the print bed. The at least one parameter may include a pressure differential between the reservoir and the build chamber. The at least one parameter may include an intensity of an electrostatic field. The at least one parameter may include an amount or concentration of an additive for mixing with the metal. The additive manufacturing system may further include a temperature control system for adjusting a temperature of one or more of the heater, the print bed, and at least a portion of a volume of the build chamber. The metal may include a metallic alloy.

A metallic electrohydrodynamic (EHD) three-dimensional printer fabricates an object while surface characteristics of the object are monitored. Sensors acquire data on surface characteristics, and feedback related to these surface characteristics is used to adjust the fabrication process, e.g., where the surface characteristics deviate from a target surface shape.

In an aspect, a method for additive manufacturing includes fabricating an object based on a three-dimensional model with a printer, where the printer is a three-dimensional metallic printer configured to additively manufacture the object with a number of droplets of liquefied metal as a build material using a metallic liquid expeller, acquiring surface data from the object with one or more sensors during fabrication, the surface data characterizing a location on a layer of a build material of the object deposited by the printer, estimating a target surface shape for the build material at the location based on the three-dimensional model, comparing the surface data to the target surface shape at the location, and adjusting a fabrication process when a discrepancy is identified between the surface data and the target surface shape.

Implementations may include one or more of the following features. The metallic liquid expeller may be configured to drive the droplets of liquefied metal by applying an electrostatic field to a meniscus of the liquefied metal extending from an outlet of the metallic liquid expeller of the printer. The surface data may be acquired for each one of the droplets of liquefied metal. The surface data may be acquired for a surface region about the location. The surface data may be acquired for a voxel about the location. The method may further include capturing process data characterizing the droplets of liquefied metal. The process data may include at least one of a volume of one of the droplets of liquefied metal and an average volume of the droplets of liquefied metal. The process data may include at least one of a dimension of one of the droplets of liquefied metal and an average dimension of the droplets of liquefied metal. The process data may include at least one of a velocity of one of the droplets of liquefied metal and an average velocity of the droplets of liquefied metal. The process data may include at least one of a temperature of one of the droplets of liquefied metal and an average temperature of the droplets of liquefied metal. The process data may include at least one of a distance between an expeller of the printer and the layer of the build material, a temperature of a build chamber of the printer, and a temperature of a print bed of the printer. The one or more sensors may include at least one of a contact profilometer and a non-contact profilometer. The one or more sensors may include an optical profilometer. The discrepancy may include a depression at a position in the layer of the build material, and adjusting the fabrication process includes repeating a deposition of droplets of liquefied metal at the position. The discrepancy may include a protrusion at a position in the surface of the layer of the object, and adjusting the fabrication process includes omitting a deposition of droplets of liquefied metal at the position while fabricating a second layer of the object on the layer containing the protrusion. The method may further include refinishing the location on the layer of the object when the discrepancy between the surface data and the target surface shape exceeds a predetermined threshold. The method may further include sending a notification to a user of the printer when the discrepancy between the surface data and the target surface shape exceeds a predetermined threshold. The method may further include acquiring parameter data related to at least one parameter or condition of the printer present during fabrication of the layer of the build material.

In an aspect, a computer program product includes computer executable code embodied in a non-transitory computer-readable medium that, when executing on one or more computing devices in electronic communication with a three-dimensional metallic printer configured to additively manufacture an object based on a three-dimensional model with a number of droplets of liquefied metal as a build material using a metallic liquid expeller, performs the steps of acquiring surface data from the object with one or more sensors during fabrication, the surface data characterizing a location on a layer of a build material of the object deposited by the three-dimensional metallic printer, estimating a target surface shape for the build material at the location based on the three-dimensional model, comparing the surface data to the target surface shape at the location, and adjusting a fabrication process of the three-dimensional metallic printer when a discrepancy is identified between the surface data and the target surface shape.

In yet another aspect, an additive manufacturing system includes a three-dimensional metallic printer configured to additively manufacture an object based on a three-dimensional model with a number of droplets of liquefied metal as a build material using a metallic liquid expeller, and a controller in electronic communication with the three-dimensional metallic printer over a data network, the controller including a processor and a memory, the memory bearing computer executable code configured to perform the steps of acquiring surface data from the object with one or more sensors during fabrication, the surface data characterizing a location on a layer of a build material of the object deposited by the three-dimensional metallic printer, estimating a target surface shape for the build material at the location based on the three-dimensional model, comparing the surface data to the target surface shape at the location, and adjusting a fabrication process of the three-dimensional metallic printer when a discrepancy is identified between the surface data and the target surface shape.

Thermal parameters for an additive manufacturing process are estimated using computer modeling, and these thermal parameters are used to control the additive manufacturing process. For example, the thermal parameters may be estimated based on bulk material properties, object geometry, control signals to thermal components of a system, and so forth.

In an aspect, a method includes fabricating a metallic object on a print bed with a three-dimensional printer, estimating a thermal parameter of the metallic object, and controlling the three-dimensional printer during fabrication of the object according to the thermal parameter.

Implementations may include one or more of the following features. The three-dimensional printer may include a three-dimensional metallic printer configured to additively manufacture the metallic object with a number of droplets of liquefied metal using a metallic liquid expeller. The metallic liquid expeller may be an electrohydrodynamic expeller configured to drive the droplets of liquefied metal by applying an electrostatic field to a meniscus of the liquefied metal extending from an expeller of the three-dimensional printer. Controlling the three-dimensional printer may include controlling a mass of the number of droplets. Controlling the three-dimensional printer may include controlling a velocity of the number of droplets. The three-dimensional printer may fabricate the metallic object using fused filament fabrication. The thermal parameter may include a thermal mass of the metallic object. The thermal parameter may include a heat capacity of the metallic object. The thermal parameter may include a surface temperature of the metallic object. The surface temperature may be estimated based on one or more of a shape of the metallic object, a bulk thermal property of a build material used to fabricate the metallic object, and a control signal for one or more of a build chamber temperature or a print bed temperature. The surface temperature may be estimated based on a thermal measurement of the print bed. The thermal parameter may include a thermal resistivity of the metallic object. Controlling the three-dimensional printer may include controlling a temperature of a build chamber of the three-dimensional printer. Controlling the three-dimensional printer may include controlling a deposition rate of a metallic build material from an expeller of the three-dimensional printer. Controlling the three-dimensional printer may include controlling a temperature of the print bed.

In an aspect, a computer program product includes computer executable code embodied in a non-transitory computer-readable medium that, when executing on one or more computing devices in electronic communication with a three-dimensional printer, performs the steps of providing instructions for fabricating a metallic object on a print bed with the three-dimensional printer, estimating a thermal parameter of the metallic object, and controlling the three-dimensional printer during fabrication of the object according to the thermal parameter. The three-dimensional printer may include a three-dimensional metallic printer configured to additively manufacture the metallic object with a number of droplets of liquefied metal using a metallic liquid expeller. The metallic liquid expeller may be an electrohydrodynamic expeller configured to drive the droplets of liquefied metal by applying an electrostatic field to a meniscus of the liquefied metal extending from an expeller of the three-dimensional printer.

In yet another aspect, an additive manufacturing system includes a three-dimensional metallic printer configured to additively manufacture a metallic object with a number of droplets of liquefied metal using a metallic liquid expeller, and a controller in electronic communication with the three-dimensional metallic printer over a data network, the controller including a processor and a memory, the memory bearing computer executable code configured to perform the steps of fabricating the metallic object on a print bed with the three-dimensional metallic printer, estimating a thermal parameter of the metallic object, and controlling the three-dimensional printer during fabrication of the object according to the thermal parameter. The metallic liquid expeller may be an electrohydrodynamic expeller configured to drive the droplets of liquefied metal by applying an electrostatic field to a meniscus of the liquefied metal extending from an expeller of the three-dimensional printer.

### BRIEF DESCRIPTION OF THE DRAWINGS

The foregoing and other objects, features and advantages of the devices, systems, and methods described herein will be apparent from the following description of particular embodiments thereof, as illustrated in the accompanying drawings. The drawings are not necessarily to scale, emphasis instead being placed upon illustrating the principles of the devices, systems, and methods described herein.

FIG. 1 depicts an additive manufacturing system.

FIG. 2 depicts an expeller of an additive manufacturing system.

FIG. 3 depicts an expeller of an additive manufacturing system.

FIG. 4 depicts a cutaway of an expeller including multiple outlets.

FIG. 5 is a flow chart of a method for additive manufacturing.

FIG. 6 is a flow chart of a method for controlling an additive manufacturing process using estimated thermal parameters.

FIG. 7 depicts a computer system.

### DETAILED DESCRIPTION

The embodiments will now be described more fully hereinafter with reference to the accompanying figures, in which preferred embodiments are shown. The foregoing may, however, be embodied in many different forms and should not be construed as limited to the illustrated embodiments set forth herein. Rather, these illustrated embodiments are provided so that this disclosure will convey the scope to those skilled in the art.

All documents mentioned herein are incorporated by reference in their entirety. References to items in the singular should be understood to include items in the plural, and vice versa, unless explicitly stated otherwise or clear from the context. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the embodiments.

In the following description, it is understood that terms such as “first,” “second,” “top,” “bottom,” “up,” “down,” and the like, are words of convenience and are not to be construed as limiting terms unless specifically stated to the contrary.

Described herein are devices, systems, and methods related to three-dimensional printing, where a design, such as a computer-aided drafting (CAD) file, is provided to a computer operably connected to a three-dimensional printer (e.g., a three-dimensional metal printer), and the object represented by the design may be manufactured in a layer-by-layer fashion by the three-dimensional printer.

In general, the following description emphasizes three-dimensional printers using metal as a build material for forming a three-dimensional object. More specifically, the description emphasizes metal three-dimensional printers that deposit metal for forming a three-dimensional object using, e.g., an electrohydrodynamic force to control delivery of a liquid metal from an expeller. However, it will be understood that, unless explicitly stated to the contrary or otherwise clear from the context, the metal three-dimensional printers may also or instead control delivery of a liquid metal build material using, e.g., a gas feed, a piezoelectric drop-on-demand droplet generator, an ultrasonic generator, and the like. Additionally, such printers may usefully print with other materials, e.g., for support structures or the like, alternately or concurrently with the deposition of metal. Some of the techniques contemplated herein may also be usefully adapted for use with metal three-dimensional printers using fused filament fabrication or similar techniques where a bead of material is extruded in a layered series of two dimensional patterns as “roads,” “paths,” or the like to form a three-dimensional object from a digital model.

Thus, although the devices, systems, and methods emphasize metal three-dimensional printing using electrohydrodynamic forces, a skilled artisan will recognize that many of the techniques discussed herein, specifically techniques related to monitoring or analyzing a three-dimensional build (e.g., during a physical build process, before a physical build process, or after a physical build process) may be adapted to three-dimensional printing using other materials (e.g., thermoplastics and the like) and other additive fabrication techniques including without limitation multijet printing, stereolithography, Digital Light Processor (“DLP”) three-dimensional printing, selective laser sintering, and so forth. Such techniques may benefit from the systems and methods described below, and all such printing technologies are intended to fall within the scope of this disclosure, and within the scope of terms such as “printer,” “three-dimensional printer,” “fabrication system,” “additive manufacturing system,” and so forth, unless a more specific meaning is explicitly provided or otherwise clear from the context.

Therefore, methods and techniques of the present disclosure can be performed, unless otherwise indicated, in analogy to methods known in polymer additive manufacturing, carbon fiber additive manufacturing, and metal powder additive manufacturing, examples of which are disclosed in U.S. Pat. No. 5,121,329; U.S. Pat. No. 5,503,785; U.S. Pat. No. 8,765,045; U.S. patent application Ser. No. 13/343,651, filed Jan. 4, 2012; U.S. patent application Ser. No. 13/587,002, filed Aug. 16, 2012; U.S. patent application Ser. No. 13/949,946, filed Jul. 24, 2013; and U.S. patent application Ser. No. 14/297,437, filed Jun. 5, 2014. All of the above, and any other publications, patents, and published patent applications referred to in this application are specifically incorporated herein by reference in their entirety. In case of conflict, the present specification, including its specific definitions, shall control.

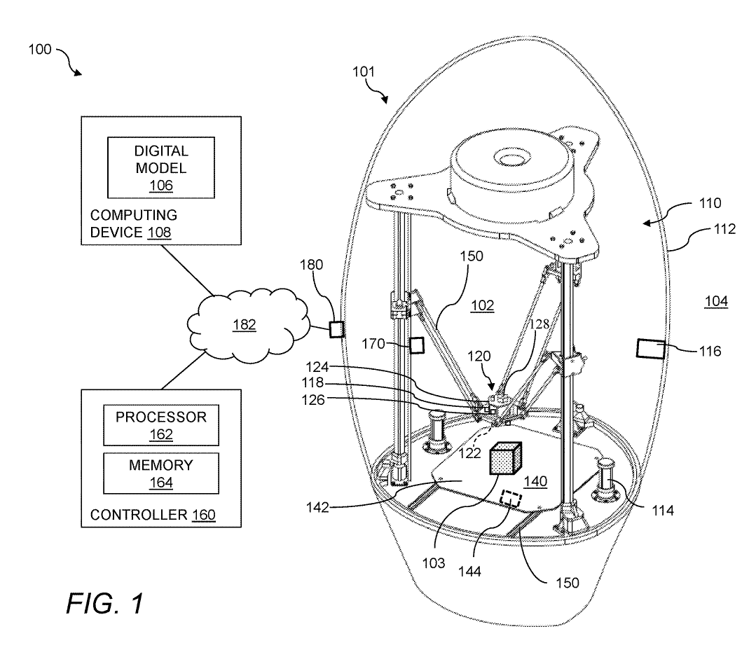

FIG. 1 depicts an additive manufacturing system. The additive manufacturing system 100 shown in the figure may be configured specifically for three-dimensional printing using a metal build material such a metallic alloy. However, the additive manufacturing system 100 may also or instead be used with other build materials including plastics, ceramics, and the like.

The additive manufacturing system 100 may include a printer 101 having a build chamber 110, an expeller 120, a print bed 140, a robotic positioning assembly 150, and a controller 160.

In general, the build chamber 110 may house the other components of the additive manufacturing system 100 including, e.g., the expeller 120, the print bed 140, and the robotic positioning assembly 150, for forming an object 103 (e.g., a three-dimensional object) within the build chamber 110. In an aspect, the build chamber 110 is environmentally sealed, where the build chamber 110 includes an enclosure 112 for environmentally sealing a build volume 102 from an external environment 104. The build chamber 110 being environmentally sealed may include a substantially air-tight or hermetically sealed chamber. The environmentally sealed build chamber 110 may be advantageous for the manufacturing of metal objects from a liquid metal, e.g., where an air-tight build chamber 110 can be purged of oxygen, or where an inert gas (or other gases such as cover gases) can be added into the build volume 102 in a controlled manner. The build chamber 110 being environmentally sealed may also or instead include a thermal seal, e.g., a seal preventing an excess of heat transfer from the build volume 102 to the external environment 104, and vice-versa. The seal of the build chamber 110 may also or instead enable control of a pressure included within the build chamber 102. To maintain the seal of the build chamber 110, any openings in the enclosure 112, e.g., for build material feeds, electronics, and so on, may similarly include seals or the like.

The build chamber 110 may include a deoxygenator 114 in communication with the build chamber 110 for purging/removing oxygen from the build chamber 110. The deoxygenator 114 may include without limitation one or more of an oxygen filter, an oxygen getter, an electrochemical oxygen pump, a cover gas supply, an air circulator, and the like. Thus, in implementations, purging the build chamber 110 of oxygen may include one or more of applying a vacuum to the build chamber 110, supplying an inert gas to the build chamber 110, placing an oxygen getter inside the build chamber 110, applying an electrochemical oxygen pump to the build chamber 110, cycling the air inside the build chamber 110 through an oxygen filter, and the like.

The build chamber 110 may include a temperature control system 116 for maintaining or adjusting a temperature of at least a portion of a volume of the build chamber 110 (the build volume 102). The temperature control system 116 may include without limitation one or more of a heater, a coolant, a fan, a blower, or the like. The temperature control system 116 may use a fluid or the like as a heat exchange medium for transferring heat as desired within the build chamber 110. The temperature control system 116 may also or instead move air (e.g., circulate air) within the build chamber 110 to control temperature, to provide a more uniform temperature, or to transfer heat within the build chamber 110.

The temperature control system 116, or any of the temperature control systems described herein (e.g., the expeller's temperature control system 126 or the print bed's temperature control system 144) may include one or more active devices such as resistive elements that convert electrical current into heat, Peltier effect devices that heat or cool in response to an applied current, or any other thermoelectric heating and/or cooling devices. Thus, the temperature control systems discussed herein may include a heater that provides active heating to the components of the printer 101, a cooling element that provides active cooling to the components of the printer 101, or a combination of these. The temperature control systems may be coupled in a communicating relationship with the controller 160 in order for the controller 160 to controllably impart heat to or remove heat from the components of the printer 101. Thus, the temperature control systems may include an active cooling element positioned within or adjacent to the components of the printer 101 to controllably cool the components of the printer 101. It will be understood that a variety of other techniques may be employed to control a temperature of the components of the printer 101. For example, the temperature control systems may use a gas cooling or gas heating device such as a vacuum chamber or the like in an interior thereof, which may be quickly pressurized to heat the components of the printer 101or vacated to cool the components of the printer 101 as desired. As another example, a stream of heated or cooled gas may be applied directly to the components of the printer 101 before, during, and/or after a build process. Any device or combination of devices suitable for controlling a temperature of the components of the printer 101 may be adapted to use as the temperature control systems described herein.

It will be further understood that the temperature control system 116 for the build chamber 110, the temperature control system 126 for the expeller 120, and the temperature control system 144 for the print bed 140 may be included in a singular temperature control system (e.g., included as part of the controller 160 or otherwise in communication with the controller 160) or they may be separate and independent temperature control systems

The build chamber 110 may include a pressure control system 118 for maintaining or adjusting a pressure of at least a portion of a volume of the build chamber 110 (e.g., an air pressure of the build volume 102). The pressure control system 118 may also or instead be used to maintain or adjust a pressure of a reservoir housing the liquid build material (e.g., liquid metal), e.g., relative to the pressure of the build chamber 110. Thus, the pressure control system 118 may be part of the expeller 120 as shown in the figure.

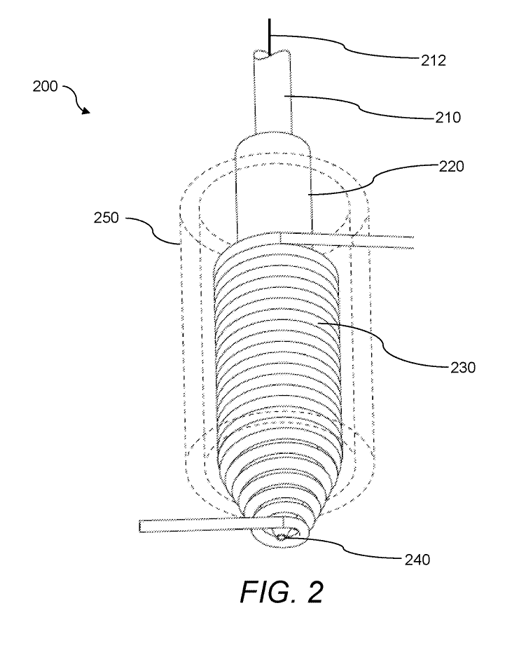

The expeller 120 (examples of which are shown in more detail in FIGS. 2-4) may include a reservoir, a heater configured to maintain a build material (e.g., a metal or metallic alloy) within the reservoir in a liquid form, and an outlet 122 within the build chamber 110. The components of the expeller 120, e.g., the reservoir and the heater, may be contained within a housing 124 or the like.

The expeller 120 or a component thereof may include or be coupled with (e.g., electronically coupled) a temperature control system 126 for maintaining or adjusting a temperature at the outlet 122 of the expeller 120 or some other location or component thereof, e.g., the reservoir. The temperature control system 126 may include without limitation one or more of the heater, a coolant, a fan, a blower, or the like.

The expeller 120 or a portion thereof may be movable within the build chamber 110 by the robotic positioning assembly 150, e.g., relative to the print bed 140. For example, the expeller 120 may be movable by the robotic positioning assembly 150 along a tool path while depositing a build material (e.g., a liquid metal) to form the object 103, or the print bed 140 may move within the build chamber 110 while the expeller 120 remains stationary.

In general, the expeller 120 may be configured to deposit a build material, e.g., a metal in liquid form, from the outlet 122. In an aspect, the expeller 120 is configured to modulate a release of the metal in the liquid form from the outlet 122 by applying an electrohydrodynamic force to control a surface tension on the metal at the outlet 122, thereby providing a supply of build material for forming the object 103. In other words, a metallic liquid expeller may be configured to drive droplets of liquefied metal from the outlet 122 of the expeller 120 by applying an electrostatic field to a meniscus of the liquefied metal extending from the outlet 122.

The expeller 120 may include or be connected to a feed 128 for build material, e.g., an opening for receiving a metal filament or the like. Specifically, the feed 128 may receive the build material into the reservoir for melting the build material into a liquid form.

The expeller 120 may include an electrohydrodynamic (EHD) device. The EHD device may include one or more electrodes coupled in electronic communication with the outlet 122, and the EHD device may be configured to drive droplets of liquefied metal from the outlet 122 by applying an electrostatic field to a meniscus of the liquefied metal extending from the outlet 122. In an aspect, a voltage difference between the build material and the one or more electrodes is configured to create the electrostatic field for modulating the surface tension or meniscus of the liquid metal sufficient to expel a droplet of the liquid metal from the outlet 122. In an aspect, a capacitance between the build material and the one or more electrodes is configured to create the electrostatic field for modulating the surface tension or meniscus of the liquid metal sufficient to expel a droplet of the liquid metal from the outlet 122.

Electrohydrodynamic forces are known for use, for example, in two-dimensional printers or surface patterning or coating systems where fine, atomizing sprays or streams can be usefully created from an electrically charged meniscus of ink or other printing material. Similar principles may be applied to create a controllable stream of liquid metal droplets although, as described herein, maintaining droplets of liquid metal that solidify upon contact with a printed object, but not beforehand, may require additional control of distance, velocity, and temperature of the expelled liquid metal, as well as additional modeling, monitoring, and/or feedback to ensure that a target three-dimensional shape is being achieved.

In some implementations, the expeller 120 may include a voltage regulator that applies an electrostatic field across a meniscus of liquid metal at the outlet 122 of the expeller 120. For steering and propulsion, a bias voltage may also be applied between the outlet 122 and a print bed 140 or other location. In some such implementations, the expeller 120 may include an EHD printing device similar to that described in Y. Han et al., “Droplet Formation and Settlement of Phase-Change Ink in High Resolution Electrohydrodynamic (EHD) 3D Printing,” JOURNAL OF MANUFACTURING PROCESSES (2015), the contents of which are herein incorporated by reference in their entirety. In some implementations in which the expeller 120 comprises an EHD printing device, the capacitance between the metal and an electrode may be designed to modulate the surface tension of the liquid metal, where one or more of the spacing between the outlet 122 and an electrode, the geometry of the outlet 122 and an electrode, and the dielectric materials between the outlet 122 and the electrode may be chosen or varied based on a desired surface tension of the liquid metal. It will be appreciated that an EHD process may generally be controlled to eject discrete droplets or a continuous stream of liquid, or some combination of these. Thus, a metallic EHD printer may usefully switch between continuous and intermittent modes during fabrication, e.g., by using a continuous stream to fill voids or openings within an object being fabricated.

In some implementations in which the expeller 120 includes a voltage regulator, the expeller 120 may further include an electrode positioned below the outlet 122. Such an electrode may be a torus or have some other suitable geometry. In such implementations, the expeller 120 may create a voltage difference between the metal build material and the electrode, thereby expelling a drop of the liquid metal past or through the electrode and onto the print bed 140. In some such implementations, the electrode may be insulated.

In some implementations, the system further comprises a plurality of electrodes positioned below a plurality of outlets (see, e.g., FIG. 4). In such implementations, each electrode may act as an independent expeller, allowing accretion to occur simultaneously at multiple parts and/or locations of an object. In some such implementations, more than one outlet in the plurality of outlets may be associated with a single reservoir, allowing multiple outlets or nozzles to share a single metal supply. In other embodiments, different outlets may provide different materials or material types, such as different metal alloys or different build materials and support materials. In some implementations in which the system comprises a plurality of electrodes, the electrodes may be printed onto a ceramic printed circuit board.

In alternate embodiments, the expeller 120 may also or instead include an ultrasonic generator, or another device in which the expeller 120 operates by acoustic droplet ejection where acoustic energy is applied to the liquid build material. In some such implementations, the expeller 120 generates ultrasonic waves. In an aspect, the expeller 120 may also or instead include a mechanical device, such as a valve, a plate with metering holes, or some other suitable mechanism.

In some implementations, the expeller 120 may include a piezoelectric material. As an illustrative example of such an implementation, the expeller 120 may include the reservoir as described herein, and a voltage may be applied to the expeller 120 to change the shape or volume of the reservoir and thereby expel a quantity of the liquid metal. Thus, actuating the expeller 120 may include applying a voltage to a piezoelectric material.

In some implementations, the expeller 120 may include an induction coil. In such implementations, the expeller 120 may magnetically control the release of the liquid metal. The induction coil may be the same coil used as the heater for the expeller 120 in an embodiment, or it may be a different coil.

In some implementations, the expeller 120 may expel 400 pL, 500 pL, 600 pL, 700 pL, 800 pL, 900 pL, 1 nL, or some other suitable volume of the liquid first metal at a time, e.g., per ejection. In some implementations, the controller 160 may be configured to select a volume of the liquid first metal to expel at any given time. Thus, the expeller 120 may usefully deliver a controllable droplet size according to, e.g., desired feature sizes, print resolution, build time, or any other process limitations or parameters.

The outlet 122 may be a hole or opening in the expeller 120 for expelling a build material. The outlet 122 may have a diameter in the range of 10 μm-1 mm, such as 10 μm, 20 μm, 30 μm, 40 μm, 50 μm, 100 μm, 1 nm, 1 mm, and so on.

In some implementations, the geometry of the reservoir and/or the outlet 122 may be designed to affect the surface tension of the liquid metal. In some implementations, the size of the reservoir and/or the outlet may be designed to affect the surface tension of the liquid metal.

The print bed 140 may be disposed within the build chamber 110 and include a surface 142 configured to receive the supply of build material to form the object 103. The surface 142 may be rigid and substantially planar, where the surface 142 is configured for receiving liquid metal droplets released from the expeller 120.

The print bed 140 may be movable within the build chamber 110, e.g., by a positioning assembly (e.g., the same robotic positioning assembly 150 that positions the expeller 120 or a different positioning assembly). Specifically, in an aspect, the print bed 140 is movable relative to the expeller 120, e.g., along one or more axes. For example, the print bed 140 may be movable along a z-axis (e.g., up and down—toward and away from the outlet 122 of the expeller 120), or along an x-y plane (e.g., side to side, for instance in a pattern that forms the tool path or that works in conjunction with movement of the expeller 120 to form the tool path for fabricating the object 103). In an aspect, the print bed 140 is rotatable.

The print bed 140 may include a temperature control system 144 for maintaining or adjusting a temperature of at least a portion of the print bed 140. The temperature control system 144 may be wholly or partially embedded within the print bed 140. The temperature control system 144 may include without limitation one or more of a heater, coolant, a fan, a blower, or the like.

The robotic positioning assembly 150 may be structurally configured to position the outlet 122 relative to the print bed 140 within the build chamber 110. The robotic positioning assembly 150 may include a Cartesian coordinate robot, a delta robot, or some other suitable robot such as depicted in the figure.

The robotic positioning assembly 150 may position the outlet 122 relative to the print bed 140 by controlling movement of one or more of the expeller 120 and the print bed 140. For example, in an aspect, the expeller 120 is operably coupled to the robotic positioning assembly 150 such that the robotic positioning assembly 150 positions the expeller 120. The print bed 140 may also or instead be operably coupled to the robotic positioning assembly 150 such that the robotic positioning assembly 150 positions the print bed 140. Or some combination of these techniques may be employed, such as by moving the expeller 120 up and down for z-axis control, and moving the print bed 140 within the x-y plane x-axis and y-axis control. In some such implementations, the robotic positioning assembly 150 may translate the print bed 140 along one or more axes, and may rotate the print bed 140.

It will be understood that a variety of arrangements and techniques are known in the art to achieve controlled linear movement along one or more axes. The robotic positioning assembly 150 may, for example, include a number of stepper motors to independently control a position of the expeller 120 or print bed 140 within the build volume 102 along each of an x-axis, a y-axis, and a z-axis. More generally, the robotic positioning assembly 150 may include without limitation various combinations of stepper motors, encoded DC motors, gears, belts, pulleys, worm gears, threads, and the like. Any such arrangement suitable for controllably positioning the expeller 120 or print bed 140 may be adapted to use with the additive manufacturing system 100 described herein.

The controller 160 may be coupled to (e.g., electronically coupled to, or otherwise in communication with) one or more components of the additive manufacturing system 100 for providing control functionality thereto. For example, in an aspect, the controller 160 may be coupled to the expeller 120 and the robotic positioning assembly 150. The controller 160 may control aspects of the expeller 120 such as a deposition rate of build material, an amount of deposited build material, and so forth. The controller 160 may control aspects of the robotic positioning assembly 150, such as the positioning of either or both of the expeller 120 or the print bed 140 relative to one another. In general, the controller 160 may be operable to control the additive manufacturing system 100 to fabricate the object 103 based on a digital model 106 that provides a three-dimensional representation of the object 103.

In some implementations, the controller 160 may be further configured to control a surface tension and/or a meniscus of the liquid metal by controlling one or more of the liquid metal's conditions. In such implementations, the controller 160 may be further configured to: apply an AC voltage signal to the metal; apply a DC voltage signal to the metal; vary the temperature of the metal; control the composition, temperature, and/or pressure of the atmosphere in the reservoir; control the composition, temperature, and/or pressure of the atmosphere below the outlet 122; apply a baseline EHD field; vary an EHD field; or otherwise suitably alter the conditions of the liquid metal.

The controller 160 may thus be electrically coupled in a communicating relationship with one or more of the various components of the additive manufacturing system 100 as described herein. In general, the controller 160 is operable to control the components of the additive manufacturing system 100, such as the expeller 120, the print bed 140, the robotic positioning assembly 150, the various temperature and pressure control systems, and any other components of the additive manufacturing system 100 described herein to fabricate the object 103 from the build material. The controller 160 may include any combination of software and/or processing circuitry suitable for controlling the various components of the additive manufacturing system 100 described herein including without limitation microprocessors, microcontrollers, application-specific integrated circuits, programmable gate arrays, and any other digital and/or analog components, as well as combinations of the foregoing, along with inputs and outputs for transceiving control signals, drive signals, power signals, sensor signals, and the like. In one aspect, the controller 160 may include a microprocessor or other processing circuitry with sufficient computational power to provide related functions such as executing an operating system, providing a graphical user interface (e.g., to a display coupled to the controller 160 or additive manufacturing system 100), convert three-dimensional models into tool instructions, and operate a web server or otherwise host remote users and/or activity through a network interface 180 for communication through a network 182.

The additive manufacturing system 100 may further include one or more sensors 170. In an aspect, the sensor 170 may be in communication with the controller 160, e.g., through a wired or wireless connection (e.g., through a data network 182). The sensor 170 may be configured to detect progress of fabrication of the object 103, and to send a signal to the controller 160 where the signal includes data characterizing progress of fabrication of the object 103. The controller 160 may be configured to receive the signal, and to adjust at least one parameter of the additive manufacturing system 100 in response to the detected progress of fabrication of the object 103.

In an aspect, the sensor 170 may be in communication with the controller 160, where the sensor 170 is configured to monitor one or more of the surface tension and a meniscus of the build material (e.g., metal) in liquid form in the expeller 120. The sensor 170 may be configured to send a signal to the controller 160 where the signal includes data characterizing one or more of the surface tension and the meniscus. In response to receiving the signal, the controller 160 may be configured to adjust at least one parameter of the additive manufacturing system 100 to control one or more of the surface tension and the meniscus.

In response to data or signals received from the one or more sensors 170, the controller 160 may be configured to apply a voltage to the build material—i.e., the liquid metal—to control one or more of the surface tension and the meniscus.

The one or more sensors 170 may include without limitation one or more of a contact profilometer, a non-contact profilometer, an optical sensor, a laser, a temperature sensor, motion sensors, an imaging device, a camera, an encoder, an infrared detector, a volume flow rate sensor, a weight sensor, a sound sensor, a light sensor, a sensor to detect a presence (or absence) of an object, and so on.

As discussed above, the controller 160 may adjust a parameter of the additive manufacturing system 100 in response to the sensor 170. The parameter of the additive manufacturing system 100 adjusted by the controller 160 in response to data or signals received from the one or more sensors 170 may include a temperature of the build material (e.g., the liquid metal), a temperature of at least a portion of a volume of the build chamber 110, and a temperature of the print bed 140. The parameter may also or instead include a pressure differential between the reservoir of the expeller and the build chamber 110, or otherwise a pressure of a portion of the build chamber 110 or the reservoir. The parameter may also or instead include an intensity of an electrostatic field. The parameter may also or instead include an amount or concentration of an additive for mixing with the build material (e.g., an additive for mixing with a metal build material).

In some implementations, the controller 160 may (in conjunction with one or more sensors 170) may identify the build material used in the additive manufacturing system 100, and may in turn adjust a parameter of the additive manufacturing system 100 based on the identification of the build material including without limitation at least one of the temperature of the build material, actuation of the expeller 120, and a position of one or more of the print bed 140 and the expeller 120 via the robotic positioning assembly 150.

An example of an operation of the additive manufacturing system 100 will now be discussed. In operation, to prepare for the additive manufacturing of an object 103, a design for the object may first be provided to a computing device 108. The design may be a digital model 106 included in a CAD file or the like. The computing device 108 may be any as described herein and may in general include any devices operated autonomously or by users to manage, monitor, communicate with, or otherwise interact with other components in the additive manufacturing system 100. This may include desktop computers, laptop computers, network computers, tablets, smart phones, smart watches, PDAs, or any other computing device that can participate in the system as contemplated herein. In one aspect, the computing device 108 is integral with the printer 101.

The computing device 108 may include the controller 160 as described herein or a component of the controller 160. The computing device 108 may also or instead supplement or be provided in lieu of the controller 160. Thus, unless explicitly stated to the contrary or otherwise clear from the context, any of the functions of the computing device 108 may be performed by the controller 160 and vice-versa. In another aspect, the computing device 108 is in communication with or otherwise coupled to the controller 160, e.g., through a network 182.

One or more of the computing device 108 and the controller 160 may include a processor 162 (and/or other processing circuitry) and a memory 164 to perform the functionality described herein and generally a variety of processing tasks related to management of the additive manufacturing system 100 as described herein. The processor 162 and memory 164 may be any as described herein or otherwise known in the art. In general, the memory 164 may contain computer code and may store data, e.g., data generated by other components of the additive manufacturing system 100.

A first build material (e.g., a first metal) may be provided to the feed 128 of the expeller 120, and the build chamber 110 may be sealed and purged of oxygen. The first metal may be a wire or filament, where the feed 128 may direct and move the wire into the reservoir of the expeller 120, e.g., via a tube that is sealed to the reservoir such that one or more of the composition, the pressure, and the temperature of the interior of the reservoir may be controlled. Once these preparatory steps have been completed, the first metal may be melted within the reservoir of the expeller 120, or melted and directed into the reservoir. The connection between the feed 128 and the reservoir may be designed to protect the feed 128 from the heat of the liquid metal, such as by thermally insulating a portion of the junction of the reservoir and the feed 128 connection. As discussed herein, the first metal may be melted by inductive heating, e.g., using a heater in the expeller 120.

In some implementations, the feed 128 includes a metal wire. In some such implementations, the wire may have a diameter of approximately 80 μm, 90 μm, 100 μm, 0.5 mm, 1 mm, 1.5 mm, 2 mm, 2.5 mm, 3 mm, or some other suitable diameter. In other implementations, the feed 128 includes a metal powder.

The computing device 108 may identify how thick each layer of the object 103 will be based on the first metal and the digital model 106, and thus the computing device 108 may identify where and how much liquid first metal should be expelled from the outlet 122 of the expeller 120 to manufacture each layer of the object 103 to match the digital model 106 of the object 103. The computing device 108 may instruct the robotic positioning assembly 150 to configure components of the additive manufacturing system 100 such that the expeller 120 expels the liquid first metal onto the print bed 140 as part of a layer of the object 103. As depicted in the figure, the expeller 120 may be attached to the robotic positioning assembly 150 such that the robotic positioning assembly 150 moves the expeller 120. In another aspect, the expeller 120 may have a fixed location, and the robotic positioning assembly 150 may move the print bed 140 relative to this fixed expeller 120. The computing device 108 may control the robotic positioning assembly 150, the heater, and the expeller 120 to create a layer of the object 103, and a subsequent layer of the object 103 on top of the previously deposited layer, and continue until the object 103 is complete. To create a layer, the computing device 108 may identify an ordered pattern of liquid metal droplets to apply to generate the layer. The computing device 108 may further identify a minimum distance between droplets that will allow each droplet to cool quickly and independently without imparting significant stress to a printed part, and may manufacture a layer by applying droplets spaced at least the minimum distance apart and applying adjacent droplets only after the earlier droplets have had sufficient time to cool.

In some implementations, the computing device 108 may receive data from a sensor 170—for example, a contact profilometer, an optical profilometer, or some other suitable sensor system used to identify features of a surface during the additive manufacturing process. As an illustrative example, the additive manufacturing system 100 may include a Dense Tracking and Mapping (DTAM) system, such as is described in R. A. Newcombe et al., “DTAM: Dense tracking and mapping in real-time,” 2011 IEEE INTERNATIONAL CONFERENCE ON COMPUTER VISION (ICCV) (2011), the contents of which are herein incorporated by reference in their entirety. In such implementations, a sensor 170 may confirm whether a layer has been formed correctly. If a portion of the layer is not within an acceptable margin of error (for example, a depression is too deep, there is a protrusion on a layer, porosity is too high, or the like), the computing device 108 may control the additive manufacturing system 100 to add more liquid metal or reduce the amount of liquid metal used on subsequent layers to correct deficiencies. In some implementations, the additive manufacturing system 100 may also or instead inform a user of manufacturing errors, adjust print parameters to correct errors, adjust output of other materials used in a design based on any identified discrepancies, or take other corrective action. In some implementations, the sensor 170 may be used to identify aberrations in the surface of the physical printed object 103 through a comparison to a design of the object 103, and the additive manufacturing system 100 may then be used to refinish the surface of the object 103.

The computing device 108 may usefully calculate the thermal mass of an object that is receiving a drop of liquid material, particularly in the location where a droplet is expected to impact the object. This may, for example, be based on the shape and size of the object (which can be estimated at any point during fabrication based on the CAD model or other digital design of the object being used to control the fabrication process), as well as the print bed 140 and any other materials between the print bed 140 and the expeller 120. Based on the thermal mass and any other relevant thermal parameters such as thermal conductivity, temperature, and so forth, the computing device 108 may adjust the relative position of the expeller 120 and the print bed 140 using the robotic positioning assembly 150, adjust the heat of the liquid material, adjust the quantity of liquid material expelled (e.g., the size or frequency of droplets), adjust the velocity of liquid metal droplets, adjust the temperature of the print bed 140, or adjust any other suitable parameters of the additive manufacturing system 100 in order to improve the consistency of the impact and freezing process.

The additive manufacturing system 100 may include, or be connected in a communicating relationship with, a network interface 180. The network interface 180 may include any combination of hardware and software suitable for coupling the controller 160 and other components of the additive manufacturing system 100 in a communicating relationship to a remote computer (e.g., the computing device 108) through a data network 182. By way of example and not limitation, this may include electronics for a wired or wireless Ethernet connection operating according to the IEEE 802.11 standard (or any variation thereof), or any other short or long range wireless networking components or the like. This may include hardware for short range data communications such as Bluetooth or an infrared transceiver, which may be used to couple into a local area network or the like that is in turn coupled to a data network such as the Internet. This may also or instead include hardware/software for a WiMax connection or a cellular network connection (using, e.g., CDMA, GSM, LTE, or any other suitable protocol or combination of protocols). Consistently, the controller 160 may be configured to control participation by the additive manufacturing system 100 in any network 182 to which the network interface 180 is connected, such as by autonomously connecting to the network 182 to retrieve printable content, or responding to a remote request for status or availability.

Examples of expellers of additive manufacturing systems will now be discussed.

FIG. 2 depicts an expeller of an additive manufacturing system. As shown in the figure, the expeller 200 may include a build material feed 210, a reservoir 220, a heater 230, an outlet 240, and a casing 250.

The build material feed 210 may include a wire feed or the like for receiving one or more wires or filament of build material 212. The build material feed 210 may also or instead include a motor or the like to push the build material 212 into the reservoir 220. The build material feed 210 may also or instead be configured to receive build material in different forms such as powder, pellets, liquid, and the like. In an aspect, the build material 212 is a metal wire.

The reservoir 220 may be substantially sealed such that melted build material can be contained within the controlled environment of the reservoir 220. The reservoir 220 may be made of metal. The metal may include a metal oxide such as an aluminum oxide, sapphire, or some other suitable metal oxide. The metal of the reservoir 220 may also or instead include one or more of tungsten, a metal carbide (e.g., a tungsten carbide), a metal nitride, and the like. The reservoir 220 may also or instead be made of other materials, e.g., ceramic materials or the like.

In some implementations, one or more of the reservoir 220 and the outlet 240 may include a material selected to affect the surface tension of the liquid metal build material. In some implementations, one or more of the reservoir 220 and the outlet 240 include a surface treatment selected to affect the surface tension of the liquid metal build material and/or the wettability of the reservoir 220 by the liquid metal build material.

In some implementations, the reservoir 220 has a volume between about 0.0001 mL and 1 mL. As an illustrative example, the reservoir 220 may comprise a hole 0.08 mm in diameter and approximately 20 mm deep. In some implementations, the reservoir 220 has a volume between about 0.0001 mL-0.04 mL. In some implementations, the reservoir 220 has a volume between about 0.01 mL and 0.04 mL. In some implementations, the reservoir 220 has a volume between about 0.1 mL-1 mL. Other volumes are also possible.

The heater 230 may be configured to maintain a metal within the reservoir 220 in a liquid form, or otherwise maintain a build material 212 in the reservoir 220 at a desired temperature or a desired physical state. The heater 230 may include an induction coil as shown in the figure, where at least a portion of the induction coil wraps at least partially around the reservoir 220. The induction coil may also or instead be used for other purposes besides heating. For example, in an aspect, release of the metal in liquid form from the outlet 240 is modulated by an inductor such as the induction coil, which is configured to control a magnetic field around the outlet 240. The magnetic field may be adjusted (tuned) for controlling the meniscus of the liquid metal at the outlet 240 for expelling the liquid metal. This may be used in addition to, or in lieu of an EHD device for expelling metal droplets of build material. Thus, in an aspect, the induction coil acts as the expeller for the system.

The heater 230 may also or instead include one or more heating blocks with resistive elements to heat the reservoir 220 with applied current, an inductive heater, or any other arrangement of heaters suitable for creating heat within the reservoir 220 to melt the build material 212.

The casing 250 may include a cover gas case or the like that introduces a cover gas over the expeller 200. The casing 250 may also or instead include an insulator, a protective casing, or the like.

Thus, in some implementations, the system may include an induction coil surrounding the reservoir, which is used to liquefy the metal build material. In some such implementations, the expeller 200 may be further configured to transmit an identification signal to the controller, which may identify the conductivity of the metal, identify the metal, identify the diameter of the outlet 240, or provide other suitable information. In such implementations, the controller may be further configured to receive the identification signal, control the quantity of the metal added to the reservoir 220 from the build material feed 210, control the heater 230 (e.g., induction coil), and control at least one of the expeller and the print bed based on the received signal, which may include controlling the temperature of the print bed, controlling the amount of liquid metal expelled by the expeller, or performing other suitable tasks. In some implementations in which the system includes an induction coil, the induction coil may for example be a 0.5 kW induction coil, a 1.0 kW induction coil, or some other suitable induction coil. When the system includes an induction coil, one or more of the frequency of the induction heating field, the magnitude of the induction heating field, and the profile of the induced current in the liquid metal may be varied to modulate a surface tension of the liquid metal.

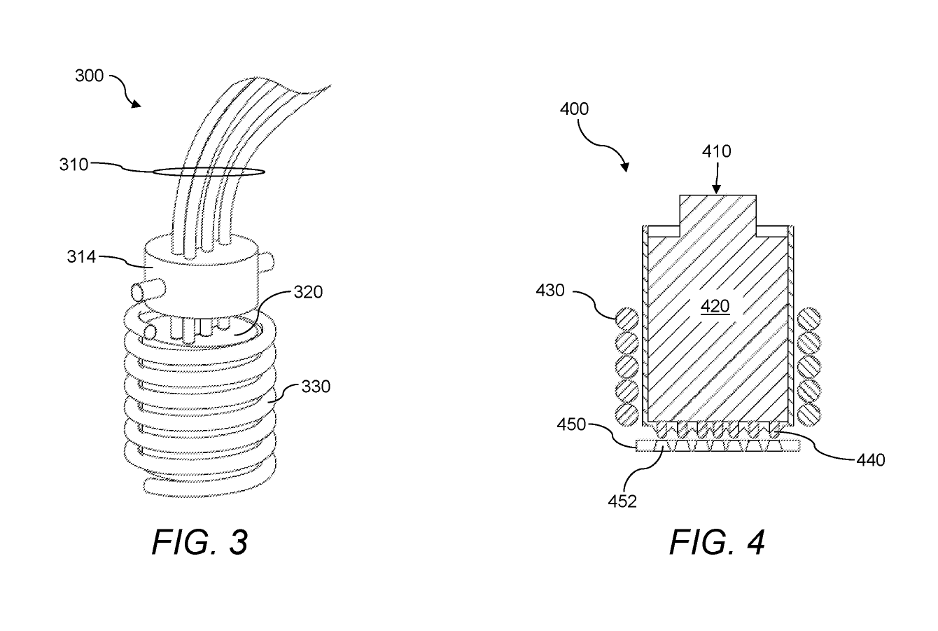

FIG. 3 depicts an expeller of an additive manufacturing system. As shown in the figure, the expeller 300 may include a plurality of feeds 310, a tube interface 314, a reservoir 320, and a heater 330.

The plurality of feeds 310 may include multiple conduits (e.g., tubes or the like) for supplying a plurality of build materials. One or more of the conduits may also or instead supply a gas, one or more additives, wiring, and the like.

The tube interface 314 may be temperature controlled in an aspect. For example, the tube interface 314 may be cooled.

The reservoir 320 may include separate reservoirs/containers therein for containing different build materials, or the different build materials may be mixed within a single reservoir/container.

FIG. 4 depicts a cutaway of an expeller including multiple outlets. As shown in the figure, the expeller 400 may include a feed 410, a heater 430, and a plurality of outlets 440 fed by a single reservoir 420.

In some implementations, there may be more than one outlet 440, and a controller or computing device may control the multiple outlets 440 to simultaneously create multiple portions of a layer of an object based on a digital design. As an illustrative example, and as is depicted in the figure, multiple outlets 440 may be connected to a single reservoir 420 heated by a single heater 430, e.g., an induction coil. Each of the outlets 440 may include its own EHD device 450 having one or more electrodes 452. In such implementations, the controller may perform raster printing using the multiple outlets 440 by translating the expeller 400 relative to the print bed (or vice-versa) using the robotic positioning assembly, actuating at least two of the EHD devices 450 while translating and shifting one or more of the expeller 400 and the print bed along a second axis orthogonal to the first axis.

As depicted in the figure, in an aspect, the reservoir 420 may be longer than its induction coil, thereby allowing for a feed wire to remain connected to the liquid metal at the bottom of the reservoir 420. In this manner, the feed wire may act as a first electrode used to set the voltage of the liquid metal, and an array of second electrodes 452 may be used for EHD printing from a plurality of outlets 440. The second electrodes 452 in such an implementation may be insulated to protect the electrodes 452 from the heat of the liquid metal.

Implementations of expellers with multiple outlets will now be discussed. Such implementations may be similar to the embodiments discussed above with reference to FIGS. 1-4, but may include additional outlets. The additional outlets may be the same type of outlets as the outlets discussed above, or they may be different outlets. The additional outlets may be positioned via the same robotic positioning system as the outlets discussed above, or by a separate robotic positioning system. Similarly, the additional outlets may be controlled by the same controller discussed above, or a separate controller.

An additive manufacturing system may include a build chamber. The additive manufacturing system may include a first expeller including a first reservoir, a first heater configured to maintain a metal within the first reservoir in a liquid form, and a first outlet within the build chamber. The first expeller may be configured to modulate a release of the metal in the liquid form from the first outlet by applying an EHD force to control a surface tension on the metal at the first outlet, thereby providing a supply of first build material. The additive manufacturing system may include a print bed within the build chamber, where the print bed includes a surface configured to receive the supply of first build material, a robotic positioning assembly structurally configured to position the first outlet relative to the print bed within the build chamber, and a controller coupled to the first expeller and the robotic positioning assembly. The controller may be operable to control the additive manufacturing system to fabricate an object based on a digital model that provides a three-dimensional representation of the object.

The additive manufacturing system may include a second expeller including a second outlet within the build chamber. The second expeller may be configured to modulate a release of a second material in a liquid form from the second outlet, thereby providing a supply of a second build material. The second expeller and the second outlet may be the same or similar to the first expeller and the first outlet, respectively, or each of the second expeller and the second outlet may be different from one or more of the first expeller and the first outlet, respectively.

The second build material may include a support material, where the second expeller is configured to deposit the support material for fabrication of a support for the object. In an aspect, the second build material includes one or more of a metal, a wax, a polymer, and a salt.

The second build material may also or instead include a metal, which may be the same as a metal that comprises the first build material or different from the metal that comprises the first build material. In an aspect, the second material includes a metal and the second expeller includes an EHD device including one or more electrodes in communication with the second outlet. In an implementation, a voltage difference between the metal and the one or more electrodes is configured to create an electrostatic field for modulating a surface tension or meniscus of the metal in a liquid form within the second outlet sufficient to expel a droplet of the metal in the liquid form from the second outlet. In an aspect, a capacitance between the metal and the one or more electrodes is configured to create an electrostatic field for modulating a surface tension or meniscus of the metal in a liquid form within the second outlet sufficient to expel a droplet of the metal in the liquid form from the second outlet.

Thus, as described above, in some implementations, a three-dimensional printer may include a second expeller associated with a second material, such as a wax, a second metal dissimilar from the first metal, a polymer, a ceramic, or some other suitable material. In such implementations, a computing device may control the second expeller as well as the first expeller to generate layers that include the first metal, the second material, or both. As an illustrative example, if a layer of the first metal is so thin that it would melt if a further drop of the first metal were placed on top of it, the computing device may use the second material to generate a thermal mass to support the thin layer and/or to serve as a heat sink to draw heat away from the thin layer. In some such implementations, expellers may be removable in part or in their entirety—that is, one or more of a material feed, a reservoir, an outlet, and an expeller may be replaced, e.g., when a stock of material is being replaced, which may include changing the material being used in manufacturing or simply refilling a supply of material. In such implementations, the robotic positioning assembly may include releasable connections for one or more material feeds, reservoirs, and/or expellers. In such implementations, one or more of the reservoir, the outlets, and the expellers may be associated with a material, e.g., a metal or class of metals. As an illustrative example, rather than using a reservoir or an outlet that can be used for any metal, an expeller that is optimized for use with steel may be used when manufacturing steel objects while a print head that is optimized for use with aluminum alloys may be used when manufacturing aluminum objects. Thus, in some implementations in which the method comprises supplying a second material to a second expeller, an embodiment includes detaching the first expeller and attaching the second expeller.

In some implementations, the system may include a second expeller, where the including a second reservoir storing a second material. The second expeller may be configured to modulate the release of the second material from the second outlet, and the second expeller may be operably connected to the controller, where the controller is further configured to control the second expeller based on a digital model or design. The second material may be a wax, a second metal (which may or may not be dissimilar to the first metal), a polymer, the first metal, or some other suitable material. The controller may be further configured to operate the first and second expellers simultaneously, independently of each other, or in some other suitable fashion. In some implementations, the controller may be configured to translate one or more of the print bed or expeller assembly across at least a portion of a range of motion along a first axis orthogonal to the first expeller, actuate at least one of the first expeller and the second expeller while or after translating the print bed or expeller assembly, and shift the print bed or expeller assembly along a second axis orthogonal to both the first axis and to the first expeller, thereby allowing raster printing. In some implementations, the controller may be configured to position the print bed or expeller assembly based on a predetermined support design, actuate the second expeller based on the predetermined support design (thereby manufacturing the support), calculate a thermal mass of the support, and adjust at least one of the temperature of the first metal, the actuation of the first expeller, and the position of the print bed or expeller assembly based on the thermal mass of the support. In some such implementations, a technique includes removing the design support, e.g., by raising the temperature of the second material to a temperature higher than the melting point of the second material but lower than the melting point of the first material.

In some implementations in which the system includes a first expeller and a second expeller, a first reservoir and a second reservoir may be located within a single induction coil.

In some implementations, the system further includes a third expeller with a third outlet, where the third expeller shares the first reservoir with the first expeller, and the third expeller is configured to interface with the third outlet and to modulate the release of the liquid first metal from the third outlet. The system may further include a fourth expeller, a fifth expeller, and so on.

As described herein, one or more of the expellers may be adapted for depositing metal. The metal may include aluminum, e.g., an aluminum alloy. The metal may also or instead include iron. For example, the metal may include a ferrous alloy such as steel, stainless steel, or some other suitable alloy. The metal may also or instead include gold, e.g., a gold alloy. The metal may also or instead include silver, e.g., a silver alloy. The metal may also or instead include one or more of a superalloy, nickel (e.g., a nickel alloy), titanium (e.g., a titanium alloy), and the like. Other metals are also or instead possible.

In alternate embodiments, the expeller may include a gas feed and a gas feed regulator, where the expeller supplies a quantity of gas to the expeller to expel a quantity of liquid metal (or other build material) from the outlet. In some such implementations, the gas feed may supply nitrogen, argon, carbon dioxide, or some other suitable gas.

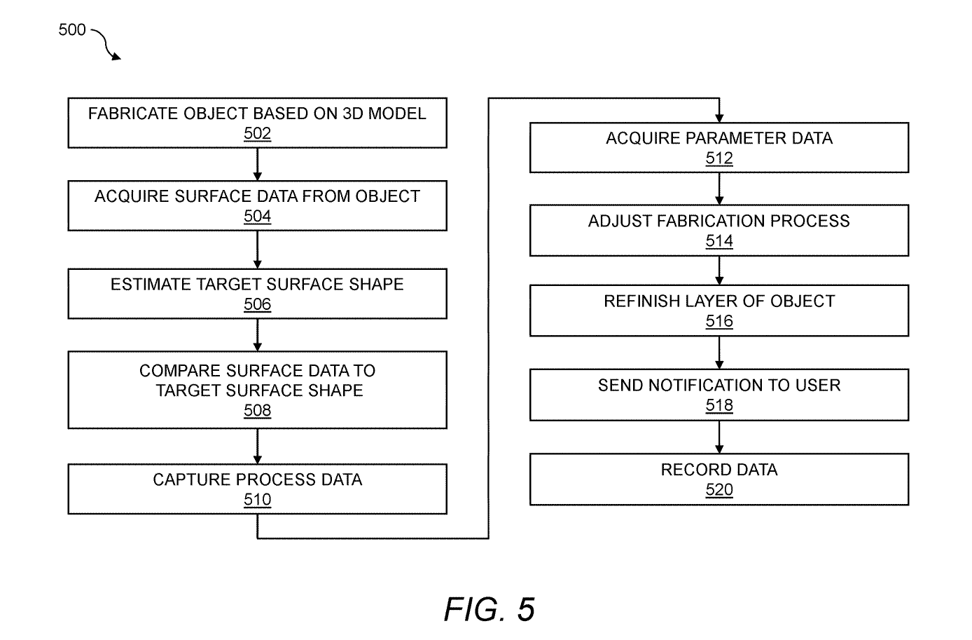

FIG. 5 is a flow chart of a method for additive manufacturing. The method may generally include controlling an additive manufacturing system (e.g., a metallic EHD three-dimensional printer) using feedback based on surface characteristics. In this manner, a printed object may be topographically monitored in real time, in addition to the real time monitoring of other characteristics of the printed object or the additive manufacturing system. Any such data may be used as feedback for adjusting a current fabrication process, or for making adjustments to subsequent fabrication processes.

As shown in step 502, the method 500 may include fabricating an object based on a three-dimensional model with a printer. The printer may be the same or similar to the printers/additive manufacturing systems discussed herein. For example, the printer may be a three-dimensional metallic printer configured to additively manufacture the object using droplets of liquefied metal as a build material, along with a metallic liquid expeller for controllably propelling the droplets of liquefied metal toward an object that is being fabricated. The metallic liquid expeller may be configured to drive the droplets of liquefied metal using electrohydrodynamic printing principles, e.g., by applying an electrostatic field to a meniscus of the liquefied metal extending from an outlet of an expeller or similar hardware.

The method 500 may be specifically advantageous to EHD metallic three-dimensional printing because each droplet is subject to a variety of forces during expulsion, travel, and impact, and the resulting surface of an object may have variations and non-uniformities rendering the object unsuitable for an intended purpose. Against this backdrop, careful control of temperature, velocity, and position may be used to generally improve uniformity of deposition. At the same time, monitoring of the surface shape may be used to identify locations where excess material is accumulating (which may result in runaway accumulation, e.g., where a surface projects into the droplet path) or to identify locations where material is failing to accumulate, e.g., where the source digital object model indicates that a structure should be present but no material has been deposited.

The method 500 may also or instead be used for other droplet-based three-dimensional printing, i.e., other than EHD printing. Thus, while an EHD printer is described in the preceding figures, these techniques may be usefully applied to a variety of other techniques for additive manufacturing based on the additive deposition of droplets of liquid metal to provide a target net shape based on, e.g., a CAD model or other source digital model for an object that is being fabricated.

As shown in step 504, the method 500 may include acquiring surface data from the object with one or more sensors during fabrication. In general, the surface data may characterize a location on a layer of a build material of the object deposited by the printer. The surface data may include information that identifies inconsistencies or errors in fabrication, such as depressions, protrusions, and the like. The surface data may thus include a build height of a layer of the object at a particular location. The surface data may also or instead include a surface map of a top layer that is currently being fabricated.

The surface data may be acquired for each one of the droplets of liquefied metal. The surface data may also or instead be acquired for a surface region about the location on the layer of build material of the object. The surface data may also or instead be acquired for a voxel about the location on the layer of build material of the object. Thus, each voxel may be analyzed and compared to a digital model to determine whether the voxel is in the correct location and whether the voxel includes the correct characteristics. In another aspect, the impact location of a droplet may be analyzed to determine whether adjustments should be made, e.g., to droplet temperature, droplet velocity, build chamber temperature, and so forth. For example, the shape of the impact location may indicate that a droplet is freezing too soon, or too late, or that the impact speed is too high, any of which might leave characteristic physical features on the surface of the object around the impact location. While it may be difficult to control parameters like temperature on a droplet-by-droplet basis, the environment within a build chamber may be continuously evaluated and adjusted to keep the environment at or near an optimum state.

The surface data may include one or more of a geometric attribute, a thermal attribute, or a physical attribute, e.g., of one or more droplets of liquefied metal or for an entire layer (or portion of a layer) of a printed object. In an aspect, the surface data includes the topography of the one or more droplets of liquefied metal or for an entire layer (or portion of a layer) of a printed object for detecting depressions, protrusions, and the like. The surface data may also or instead include a porosity of the surface of the layer of the object.

The surface data may be acquired on a predetermined basis, e.g., where frequency of acquiring the surface data is based on one or more of time, layer number, fabrication progress (e.g., percent complete), and so forth. For example, the surface data may be acquired for every layer, or every N layers. In an aspect, the frequency for acquiring surface data is variable. For example, the surface data may be acquired every N layers, but when a correction or other remedial action is called for, the surface data may then be acquired every layer until the correction is no longer needed. The frequency for acquiring surface data may also or instead be “active”—e.g., the frequency may be increased or decreased depending on how much correction is called for in previous layers of the build. Frequency may be a factor in the method 600 because not acquiring surface data for every layer (and correcting every layer) can minimize the build time. The frequency of acquiring surface data may be based on the type of additive manufacturing process, the type of object being fabricate, the build material, time constraints, quality control parameters, and the like.

When evaluating characteristics of the object to be fabricated (and supports), the characteristics at intermediate stages of printing may also be considered. In some cases, reasonable estimates may be achieved by looking at intermediate shapes after N slices are printed. Such estimates may also or instead be useful for techniques such as that described below in method 600.

Sensors for acquiring surface data may include profilometer such as a contact profilometer or a non-contact profilometer, or any other device suitable for measuring or otherwise characterizing the surface of the object being fabricated. The non-contact profilometer may include an optical profilometer or a laser. The one or more sensors may also or instead include a camera. The one or more sensors may be positioned within the build chamber, or may otherwise be in communication with the build chamber to detect characteristics of a surface positioned within the build chamber.

As shown in step 506, the method 500 may include estimating a target surface shape for the build material at the location on the layer based on the three-dimensional model. The target surface shape may thus include model data related to a portion in the digital model corresponding to the location on the layer of the object. In other words, the target surface shape may include what the three-dimensional model indicates should be present at the location where surface data is acquired, and at the current time within the build process. Thus, the digital source model may be used to estimate an aggregate surface shape that is expected at a particular moment during the build—specifically the moment when the surface measurement is captured with the sensors. In another aspect, the target surface shape may be based on other parameters such as the expected pattern or surface shape that will be left by droplets of EHD-propelled liquid metal when the system is operating properly.

As shown in step 508, the method 500 may include comparing the surface data to the target surface shape at the location on the layer. The comparison may include identifying a discrepancy between the surface data and the target surface shape. The discrepancy may be compared to a threshold value, and if the discrepancy is greater than the threshold value, action may be taken such that the discrepancy between the surface data (or subsequent surface data) and the target surface shape is lessened or eliminated. For example, the threshold value may allow for normal process variability that is expected for a properly working printer. The corrective action may include adjusting a fabrication process as explained below in step 514. Before an action is taken, however, other data may be gathered by the system as explained below. Gathering this additional data may assist in acquiring a complete picture for the additive manufacturing process such that appropriate action can be taken in response to an identified discrepancy.

As shown in step 510, the method 500 may include capturing process data. The process data may characterize one or more droplets of liquefied metal. For example, the process data may include a volume of one of the droplets of liquefied metal, or an average volume of the droplets of liquefied metal. The process data may also or instead include a dimension of one of the droplets of liquefied metal, or an average dimension of the droplets of liquefied metal. The process data may also or instead include a velocity of one of the droplets of liquefied metal, or an average velocity of the droplets of liquefied metal. The process data may also or instead include a temperature of one of the droplets of liquefied metal, or an average temperature of the droplets of liquefied metal, e.g., when leaving the outlet of an expeller or when impacting the surface of an object that is being fabricated. The process data may also or instead include a time to deposit one of the droplets of liquefied metal, or an average time for depositing the droplets of liquefied metal. The process data may also or instead include a composition of the droplets of liquefied metal. The process data may also or instead include one or more of a mass of the droplets of liquefied metal or a density of the droplets of liquefied metal.

The process data may also or instead include information regarding the additive manufacturing system, which might not be directly related to characteristics of the one or more droplets of liquefied metal, but may nonetheless affect the formation or deposition of droplets of liquefied metal from an expeller. For example, the process data may include at least one of a distance between an outlet of an expeller of the printer and the layer of the build material (or any other position information for the expeller), a temperature of a build chamber of the printer, a temperature of a print bed of the printer, a pressure of the build chamber or a pressure difference between the expeller (or a component thereof, e.g., a reservoir) and the build chamber, an oxygen content of the build chamber, and so forth.

In general, the process data may be captured by one or more sensors of the additive manufacturing system and sent to a controller or the like for analysis.

As shown in step 512, the method 500 may include acquiring parameter data. The parameter data may be related to at least one parameter or condition of the printer present during fabrication of the layer of the build material. The parameter data may thus include print settings, or other settings for a system. The parameter data may include a setting of the distance between an outlet of an expeller of the printer and the layer of the build material, a temperature setting of a build chamber of the printer, a temperature setting of a print bed of the printer, a pressure setting of the build chamber or a pressure setting for the reservoir, an oxygen content setting of the build chamber, and so forth. The parameter data may be acquired in addition to or in lieu of the process data discussed above.

One or more of the surface data, the process data, and the parameter data may be gathered, as discussed above, on a droplet-by-droplet basis, a voxel-by-voxel basis, or on the basis of another discrete unit of build material deposited by the printer. One or more of the surface data, the process data, and the parameter data may also or instead be gathered based on time—e.g., once per 0.100 seconds, once per 0.010 seconds, once per 0.001 seconds, or another unit of time.

As shown in step 514, the method 500 may include adjusting a fabrication process when a discrepancy is identified between the surface data and the target surface shape. The fabrication process may be adjusted by a controller or the like as described herein or otherwise known in the art. Adjustment of the fabrication process may be based solely on the identification of the discrepancy between the surface data and the target surface shape, solely on the captured process data, or solely on the acquired parameter data. The adjustment of the fabrication process may instead be based on any combination of one or more of the discrepancy, process data, parameter data, or other data. Additionally, any of the discrepancy data, process data, parameter data, or other data may be used to calculate other properties or characteristics of the printed part or manufacturing system, which may then be used to adjust the fabrication process.

Adjusting a fabrication process may include an adjustment of any suitable process parameters relating to the fabrication process. For example, adjusting the fabrication process may include adjusting one or more of a temperature of the build material, a temperature of a print bed of the printer, a temperature of a build chamber of the printer, a distance between an outlet of an expeller and a print bed of the printer, actuation of an expeller of the printer, and so forth. Adjusting the fabrication process may also include increasing or decreasing the amount of material deposited in order to compensate for deviations between the expected shape of an object (e.g., as indicated by the source digital model) and the actual shape of the object. Thus for example, adjusting the fabrication process may include adjusting a volume of build material deposited in a predetermined portion of the layer of the object, adjusting a quantity or output of a second build material by the printer, repeating deposition within an area of the surface, preventing deposition within an area of the surface, and so on. Adjusting a fabrication process may also or instead include adjusting any of the other parameters or settings discussed herein.

By way of example, the discrepancy may include a depression at a position in the layer of the build material. Based on this discrepancy between the surface data and the target surface shape, adjusting the fabrication process may include repeating a deposition of droplets of liquefied metal at the position, i.e., to fill the depression. In another example, the discrepancy may include a protrusion at a position in the surface of the layer of the object. Based on this discrepancy between the surface data and the target surface shape, adjusting the fabrication process may include omitting a deposition of droplets of liquefied metal at the position while fabricating a second layer of the object on the layer containing the protrusion—i.e., depositing droplets around the protrusion in a subsequent layer, but not on top of the protrusion to avoid exacerbating the protrusion.

The adjustment of the fabrication process may thus be a real time adjustment that attempts to bring the printed object closer to what the three-dimensional model shows.

As shown in step 516, the method 500 may include refinishing a location on the layer of the object when the discrepancy between the surface data for the location and the target surface shape exceeds a predetermined threshold. A refinishing step may be usefully performed where, for example, an appropriate amount of material has been deposited, but poor process control has resulted in generalized irregularities such as bumpiness from droplets that freeze too early or spatter across the exposed layer that is being fabricated. Refinishing may be particularly useful where, e.g., a surface is so excessively varied that it becomes difficult to fabricate a new layer on the surface, or where the surface is a roof or other exterior surface of the fabricated object. Where surface defects are particularly severe, the process may be paused so that material can be removed from the surface, or the surface can otherwise be prepared or treated to receive a new layer of build material.

As shown in step 518, the method 500 may include sending a notification to a user of the printer when the discrepancy between the surface data and the target surface shape exceeds a predetermined threshold. This may, for example, include a text message, electronic mail notification, phone call, or computer screen pop up alert notifying the user of an imminent or actual build failure.

As shown in step 520, the method 500 may include recording data. The recorded data may include one or more of the surface data, the target surface shape (or a discrepancy between the surface data and the target surface shape), the process data, the parameter data, the adjustment taken to the fabrication process, and so forth. The recorded data may also or instead include whether an adjustment to the fabrication process was successful, e.g., for remediating a discrepancy between the printed object and the three-dimensional model. This information may be used, e.g., to detect emerging maintenance needs for a machine, or to improve future builds of the object by the same printer or similarly configured printers. The recorded data may include data on every droplet or every voxel. The recorded data may include many aspects of the build history for an object. This may, for example, include the source digital model, any input print parameters used for a particular print job, as well as logging data obtained during the print. In one aspect, this may include direct logging of parameters such as temperature, pressure, etc. In another aspect, this may include monitoring of deviations from the model, surface defects that are detected, and so forth. In general, all of this data may be temporally and spatially logged so that after an object is created, the conditions during any moment and at any location within the object can be reviewed. In general, this data may be spatially stored at any suitable intervals such as for each liquid droplet or voxel, or at temporal intervals such as once per second or fraction thereof.

The recorded data may be useful for identifying patterns, e.g., patterns related to where discrepancies tend to occur in a layer of an object, patterns related to process data or parameter data that tend to cause discrepancies or remediate discrepancies, patterns related to adjustments in the fabrication process that tend to remediate discrepancies or exacerbate discrepancies, and so forth. The recorded data may reveal patterns that affect the physical integrity of printed objects, thermal properties of printed objects, geometric properties of printed objects, or other characteristics of printed objects such as mass. Thus, the method 500 may include analyzing the recorded data to identify a pattern where discrepancies exist.

The recorded data may be used for data analytics related to the additive manufacturing of objects. For example, using the recorded data or otherwise using disclosed techniques, failures or defects can be traced back to where they occurred during fabrication for accurate manufacturing analytics. By way of example, using the data, a pattern can reveal that a certain type of raw material used at a certain point in a manufacturing process for a certain type of object is causing a failure or defect.

Using the method 500, defects in a printed object may be detected and specific, detailed information may be gathered including what the defect is, where the defect is, and what the processing conditions and parameters were when the defect occurred. Moreover, using the detailed information gathered by the techniques described herein may yield a thermal budget on a voxel-by-voxel basis, where the system obtains a time and temperature for each voxel.

Using the method 500, a comparison between an expected mass (using the three-dimensional model) and an actual mass (calculated using the data gathered by the techniques described herein) may be achieved. This may be particularly useful if a printed object requires further finishing in which material will be removed. In a similar manner, techniques may reveal how much build material was extruded for a particular printer part (or portion of a particular part), e.g., using the volume, mass, or density of the build material on a voxel-by-voxel basis.

Thus, as described above, in some implementations, a method may include identifying an expected surface of the predetermined design, identifying a deviation in a surface of the object from the expected surface, and adjusting at least one of the temperature of the first metal, the actuation of the first expeller, and the position of the robotic platform based on the identified deviation to correct the identified deviation. In some such implementations, the deviation may be identified with a contact profilometer, a non-contact profilometer (e.g., an optical profilometer), or some other suitable sensors. As an illustrative example, the method may even out an undesirable depression in a surface by adding more of the liquid first metal to the identified depression, or may correct for an undesirable lump on a surface by reducing the amount of the liquid first metal that would otherwise be supplied in forming a layer on top of the surface.

In an implementation, a computer program product including computer executable code embodied in a non-transitory computer-readable medium that, when executing on one or more computing devices in electronic communication with a three-dimensional metallic printer configured to additively manufacture an object based on a three-dimensional model with a number of droplets of liquefied metal as a build material using a metallic liquid expeller, may perform the steps of the method 500 above. For example, the computer program product may include computer executable code that performs the steps of acquiring surface data from the object with one or more sensors during fabrication, the surface data characterizing a location on a layer of a build material of the object deposited by the three-dimensional metallic printer, estimating a target surface shape for the build material at the location based on the three-dimensional model, comparing the surface data to the target surface shape at the location, and adjusting a fabrication process of the three-dimensional metallic printer when a discrepancy is identified between the surface data and the target surface shape.

In an implementation, an additive manufacturing system may include a three-dimensional metallic printer such as any of the printers described herein. The three-dimensional metallic printer may be configured to additively manufacture an object based on a three-dimensional model with a number of droplets of liquefied metal as a build material using a metallic liquid expeller. The additive manufacturing system may further include a controller in electronic communication with the three-dimensional metallic printer over a data network. The controller may include a processor and a memory, where the memory bears computer executable code configured to perform the steps of acquiring surface data from the object with one or more sensors during fabrication, the surface data characterizing a location on a layer of a build material of the object deposited by the three-dimensional metallic printer, estimating a target surface shape for the build material at the location based on the three-dimensional model, comparing the surface data to the target surface shape at the location, and adjusting a fabrication process of the three-dimensional metallic printer when a discrepancy is identified between the surface data and the target surface shape.

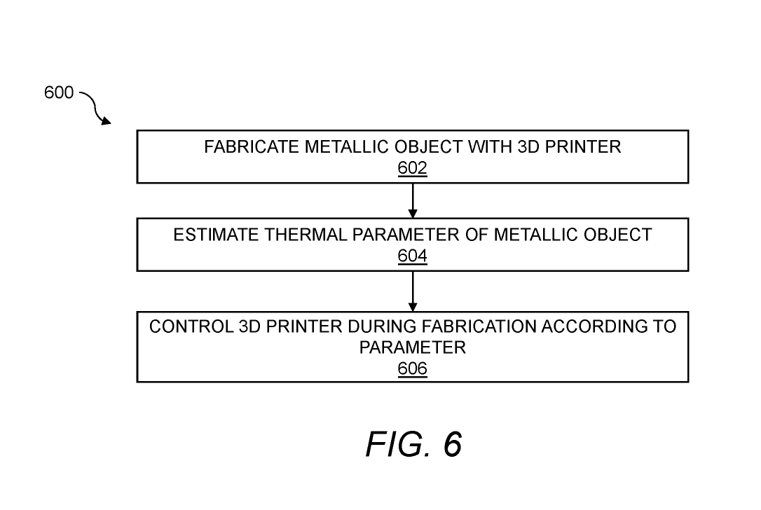

FIG. 6 is a flow chart of a method for controlling an additive manufacturing process using estimated thermal parameters. Some thermal properties are amenable to direct measurement during a fabrication process, such as surface temperature where material is being deposited. However, other thermal properties may be highly relevant to consistent print quality but difficult to measure directly. For example, the thermal mass of an object that is receiving droplets of liquid metal may be relevant to the freezing process by which the liquid metal converts to a solid, and the thermal mass around the target surface may affect the size or velocity of an optimized droplet that should be dispensed by the expeller. Similarly, thermal conduction paths may significantly affect the conversion of heat applied at a print bed into surface temperature on a top layer being fabricated. These types of thermal parameters may be usefully estimated during fabrication even in the absence of direct physical measurement by using, e.g., physical modeling or any other suitable techniques to draw accurate quantitative inferences based upon known information about bulk material properties, a current geometric shape of an object, and so forth. Even where direct measurements are possible, estimation may be used predictively, e.g., to predict a temperature at the surface of the object at a point in time based on an indirect application of thermal energy at, e.g., a heated print bed. More generally, an estimated thermal parameter may be any parameter calculated or estimated based on known thermal properties of the build material, geometry of an object, and indirect sources of heat during the fabrication process.

As shown in step 602, the method 600 may include fabricating a metallic object on a print bed with a three-dimensional printer. The three-dimensional printer may include any of the printers or additive manufacturing systems described herein. For example, the three-dimensional printer may include a three-dimensional metallic printer configured to additively manufacture the metallic object with a number of droplets of liquefied metal using a metallic liquid expeller. The metallic liquid expeller may include an electrohydrodynamic expeller configured to drive the droplets of liquefied metal by applying an electrostatic field to a meniscus of the liquefied metal extending from an outlet of an expeller of the three-dimensional printer.

In another implementation, the three-dimensional printer may fabricate the metallic object using fused filament fabrication. In yet another implementation, the method 600 may be used for non-metallic three-dimensional printing, e.g., the three-dimensional printing of thermoplastics and the like. In other implementations, the method 600 may be used for additional types of three-dimensional printing including without limitation one or more of binder jet printing, multijet printing, stereolithography, DLP three-dimensional printing, selective laser sintering, and so forth. In general, the method 600 may be used for an additive manufacturing technique where a transfer of thermal energy is relevant to the manufacturing process.

As shown in step 604, the method 600 may include estimating a thermal parameter of the metallic object. In an aspect, the thermal parameter includes a thermal mass of the metallic object. The thermal parameter may also or instead include a heat capacity of the metallic object. In another aspect, the estimated thermal parameter may include a thermal conductivity of the metallic object. In another aspect, the estimated thermal parameter may be an estimated temperature at some location at the surface of or within an interior of the object being fabricated, such as a surface location where new build material is being deposited.

The thermal parameter may be related to a printing surface or substrate of the metallic object in which droplets of liquefied metal will be deposited, e.g., a previously deposited layer of the metallic object. For example, the thermal parameter may include a surface temperature of the metallic object. The surface temperature may be estimated based on one or more of a shape of the metallic object, a bulk thermal property of a build material used to fabricate the metallic object, and a control signal for a thermal component of the printer such as a control signal for a heater that controls the build chamber temperature or a heater that controls a print bed temperature. For example, an estimation of the surface temperature may be made if known variables in an additive manufacturing system include, e.g., the temperature of the print bed (or a temperature setting of the print bed), the temperature of the build chamber (or a temperature setting of the build chamber), the height of the surface above the print bed (or an estimated height), the amount of build material below the surface (or an estimated amount of material), and a bulk thermal property of the build material (e.g., a thermal resistivity or thermal conductivity of the build material)—i.e., through heat transfer calculations. In this manner, the surface temperature may be estimated based on control signals sent to the print bed rather than direct measurement of the surface temperature. This technique also permits prospective or predictive estimation of the surface temperature of the object at some future point in time based on a control signal selected for the print bed or some other thermal element of the printer. For example, the surface temperature of the object at a location where material is to be deposited can be usefully controlled using these techniques despite the potential for significant latency between a change in the print bed temperature and a resulting change in surface temperature for an object on the print bed.

The thermal parameter may also or instead be estimated for one or more supports for the metallic object.

As shown in step 606, the method 600 may include controlling the three-dimensional printer during fabrication of the object according to the thermal parameter. In an aspect where the three-dimensional printer includes a three-dimensional metallic printer configured to additively manufacture the metallic object with a number of droplets of liquefied metal using a metallic liquid expeller, controlling the three-dimensional printer may include controlling a mass of the number of droplets. In such an aspect, controlling the three-dimensional printer may also or instead include controlling a velocity of the number of droplets. Thus, in general, controlling the three-dimensional printer may include controlling actuation of an expeller of the three-dimensional printer based on, e.g., an estimated thermal mass or surface temperature of an object at a location where material is being deposited.

In an aspect, controlling the three-dimensional printer includes controlling a temperature of a build chamber of the three-dimensional printer. Controlling the three-dimensional printer may also or instead include controlling a temperature of the print bed. As noted above, control signals may be usefully adjusted based on thermal modeling so that a target temperature is maintained at the surface during deposition of metal. Controlling the three-dimensional printer may also or instead include controlling a temperature of the build material, or a pressure of a reservoir storing liquid build material.

Controlling the three-dimensional printer may also or instead include controlling a deposition rate of a metallic build material from an expeller of the three-dimensional printer. Controlling the three-dimensional printer may also or instead include controlling a distance between an expeller and the print bed of the three-dimensional printer. Controlling the three-dimensional printer may also or instead include controlling a volume of a discrete unit of build material to be deposited by the three-dimensional printer (e.g., per layer or per other unit volume or area).

Controlling the three-dimensional printer may also or instead include controlling the composition of build material. For example, where the build material is metal, controlling the three-dimensional printer may include controlling an amount or concentration of an additive for mixing with the metal.

Controlling the three-dimensional printer may also or instead include adjusting a tool path for an expeller or print bed of the three-dimensional printer to form the three-dimensional object based on the estimated thermal parameter. Controlling the three-dimensional printer may also or instead include sending a notification to a user of the three-dimensional printer based on the estimated thermal parameter, e.g., when there is a discrepancy between the thermal parameter and a predetermined threshold.

The method 600 may be performed independent of any sensors measuring aspects of the additive manufacturing system. In this manner, a digital model of an object to be formed may be used to gather information concerning physical properties of the object for estimating the thermal parameter, along with temperature settings of components of the additive manufacturing system. Thus, even before an object is printed, the method 600 may estimate the thermal mass of the object on a layer-by-layer basis. For example, using the digital model, one or more printing surfaces may be identified that include surfaces upon which build material will be deposited by an expeller of the additive manufacturing system to form the object. The thermal parameter may be estimated for each of these surfaces, or for discrete portions of these surfaces, or for a relevant three-dimensional volume around a location of interest.

These techniques for estimation may also or instead be used in a feedback manner to improve control over a printing process. For example, based on this information, a discrete portion of the object may be identified where there is a discrepancy between the estimated thermal parameter for the discrete portion and a predetermined threshold for the thermal parameter. Based on this discrepancy, the fabrication process may be adjusted to compensate for the discrepancy. For example, where a predicted surface temperature becomes too low or too high, a heating system within the printer may be adjusted accordingly to prevent excessive excursions from target fabrication conditions.

By way of example, an analysis using the method 600 above may include identifying that a layer of an object is estimated to be cooler than a preferred substrate temperature when that layer will act as the deposition surface for the next layer, e.g., based on its height above a heated print bed. Thus, an adjustment may be made to the additive manufacturing system when printing on this layer based on the estimation, e.g., increasing the temperature of the print bed. Similarly, heating of the build chamber of a three-dimensional printer may be increased if it is estimated that the substrate gets cooler as the height above the print bed is increased for the printed object.

In an implementation, a computer program product including computer executable code embodied in a non-transitory computer-readable medium that, when executing on one or more computing devices in electronic communication with a three-dimensional printer, may perform the steps of the method 600 above. For example, the computer program product may include computer executable code that performs the steps of providing instructions for fabricating a metallic object on a print bed with the three-dimensional printer, estimating a thermal parameter of the metallic object, and controlling the three-dimensional printer during fabrication of the object according to the thermal parameter.

In an implementation, an additive manufacturing system may include a three-dimensional metallic printer configured to additively manufacture a metallic object with a number of droplets of liquefied metal using a metallic liquid expeller, and a controller in electronic communication with the three-dimensional metallic printer over a data network. The controller may include a processor and a memory, where the memory bears computer executable code configured to perform the steps of fabricating the metallic object on a print bed with the three-dimensional metallic printer, estimating a thermal parameter of the metallic object, and controlling the three-dimensional printer during fabrication of the object according to the thermal parameter.

In some implementations, a method may include calculating a thermal mass of a surface disposed beneath a first expeller, and adjusting at least one of the temperature of a build material, the actuation of the first expeller, and the position of one or more of the expeller or the print bed based on the identified thermal mass. In some such implementations, the method may further include measuring or adjusting a temperature of the print bed, the build chamber, or the build material.

In some implementations, a method may include an additive manufacturing technique. In such aspects, the method may include supplying a first metal to a first expeller, where the first expeller includes a first reservoir, a first outlet, and a metal feed. The method may include melting the first metal into the first reservoir, moving a robotic positioning assembly based on a predetermined design (such as a computer-aided design file), and actuating a first expeller to release a quantity of the liquid first metal from the first outlet based on the predetermined design, thereby manufacturing an object. In some implementations, the first expeller and the robotic positioning assembly are in an air-tight chamber. In some such implementations, the method further comprises one or more of applying a vacuum to the air tight chamber and introducing an inert gas into the air-tight chamber.

In some implementations, a method includes applying one or more voltages to each electrode in a plurality of electrodes positioned below a plurality of outlets. In such implementations, each electrode may act as an independent expeller, allowing a system to build multiple portions of a design simultaneously. In some such implementations, more than one outlet in the plurality of outlets may be associated with a single reservoir, allowing multiple expellers to share a single metal supply. In some implementations, the electrodes may be printed onto a ceramic printed circuit board.

In some implementations, a method includes altering one or more conditions of a liquid metal to control its surface tension and/or meniscus. In such implementations, the method may include one or more of: applying an AC voltage signal to the metal; applying a DC voltage signal to the metal; varying the temperature of the metal; controlling the composition, temperature, and/or pressure of the atmosphere in the reservoir containing the metal; controlling the composition, temperature, and/or pressure of the atmosphere below the first outlet; applying a baseline EHD field; varying an EHD field; or otherwise suitably altering the conditions of the liquid metal.

While various embodiments of the present disclosure have been shown and described herein, it will be obvious to those skilled in the art that such embodiments are provided by way of example only. Numerous variations, changes, and substitutions will now occur to those skilled in the art without departing from the disclosure. For example, the first expeller may be mounted on a robotic positioner capable of moving along a plane parallel to the print bed, while the print bed may be mounted on a robotic positioner capable of moving perpendicularly to the print bed, towards and away from the first expeller. Likewise, the first expeller may be capable of issuing a continuous stream of liquid metal instead of or in addition to single drops of liquid metal. Elements of an implementation of the systems and methods described herein may be independently implemented or combined with other implementations.

Having provided an overall context for various additive manufacturing devices, systems, methods, and techniques, the description now turns to a brief discussion of an example of a computer system that may be used with any of the devices, systems, methods, and techniques above.

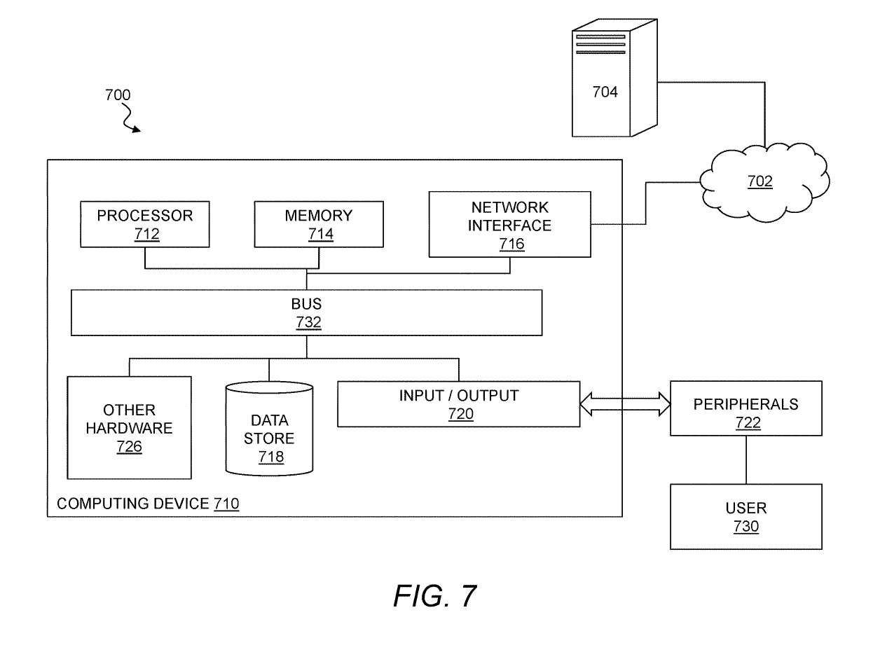

FIG. 7 illustrates a computer system. Specifically, the figure shows a representation of a computing system 700 that can be used to implement or support any of the components of the devices, systems, and methods described herein. A print engine controlling any of the components of the devices, systems, and methods described herein may be implemented on one or more computing devices 710 having suitable circuitry. In certain aspects, a plurality of the components of a print engine controlling any of the components of the devices, systems, and methods described herein may be included within one computing device 710. In certain implementations, a component of a print engine controlling any of the components of devices, systems, and methods described herein may be implemented across several computing devices 710.

In general, the computer system 700 may include a computing device 710 connected to a network 702, e.g., through an external device 704. The computing device 710 may be or include any type of device as described herein, e.g., with reference to FIG. 1 above. By way of example, the computing device 710 may include any of the controllers described herein (or vice-versa), or otherwise be in communication with any of the controllers or other devices described herein. For example, the computing device 710 may include a desktop computer workstation. The computing device 710 may also or instead be any suitable device that has processes and communicates over a network 702, including without limitation a laptop computer, a desktop computer, a personal digital assistant, a tablet, a mobile phone, a television, a set top box, a wearable computer (e.g., watch, jewelry, or clothing), a home device, just as some examples. The computing device 710 may also or instead include a server, or it may be disposed on a server.

The computing device 710 may be used for any of the devices and systems described herein, or for performing the steps of any method described herein. For example, the computing device 710 may include a controller or any computing devices described therein. In certain aspects, the computing device 710 may be implemented using hardware (e.g., in a desktop computer), software (e.g., in a virtual machine or the like), or a combination of software and hardware, and the computing device 710 may be a standalone device, a device integrated into another entity or device, a platform distributed across multiple entities, or a virtualized device executing in a virtualization environment. By way of example, the computing device may be integrated into a controller or three-dimensional printer.

The network 702 may include any network described above, e.g., data network(s) or internetwork(s) suitable for communicating data and control information among participants in the computer system 700. This may include public networks such as the Internet, private networks, and telecommunications networks such as the Public Switched Telephone Network or cellular networks using third generation cellular technology (e.g., 3G or IMT-2000), fourth generation cellular technology (e.g., 4G, LTE. MT-Advanced, E-UTRA, etc.) or WiMax-Advanced (IEEE 802.16m)) and/or other technologies, as well as any of a variety of corporate area, metropolitan area, campus or other local area networks or enterprise networks, along with any switches, routers, hubs, gateways, and the like that might be used to carry data among participants in the computer system 700. The network 702 may also include a combination of data networks, and need not be limited to a strictly public or private network.

The external device 704 may be any computer or other remote resource that connects to the computing device 710 through the network 702. This may include print management resources, gateways or other network devices, remote servers or the like containing content requested by the computing device 710, a network storage device or resource, a device hosting printing content, or any other resource or device that might connect to the computing device 710 through the network 702.

The computing device 710 may include a processor 712, a memory 714, a network interface 716, a data store 718, and one or more input/output devices 720. The computing device 710 may further include or be in communication with peripherals 722 and other external input/output devices 724.

The processor 712 may be any as described herein, and in general be capable of processing instructions for execution within the computing device 710 or computer system 700. The processor 712 may include a single-threaded processor or a multi-threaded processor. The processor 712 may be capable of processing instructions stored in the memory 714 or on the data store 718.

The memory 714 may store information within the computing device 710 or computer system 700. The memory 714 may include any volatile or non-volatile memory or other computer-readable medium, including without limitation a Random Access Memory (RAM), a flash memory, a Read Only Memory (ROM), a Programmable Read-only Memory (PROM), an Erasable PROM (EPROM), registers, and so forth. The memory 714 may store program instructions, print instructions, digital models, program data, executables, and other software and data useful for controlling operation of the computing device 700 and configuring the computing device 700 to perform functions for a user. The memory 714 may include a number of different stages and types for different aspects of operation of the computing device 710. For example, a processor may include on-board memory and/or cache for faster access to certain data or instructions, and a separate, main memory or the like may be included to expand memory capacity as desired.

The memory 714 may, in general, include a non-volatile computer readable medium containing computer code that, when executed by the computing device 700 creates an execution environment for a computer program in question, e.g., code that constitutes processor firmware, a protocol stack, a database management system, an operating system, or a combination of the foregoing, and/or code that performs some or all of the steps set forth in the various flow charts and other algorithmic descriptions set forth herein. While a single memory 714 is depicted, it will be understood that any number of memories may be usefully incorporated into the computing device 710.

The network interface 716 may include any hardware and/or software for connecting the computing device 710 in a communicating relationship with other resources through the network 702. This may include remote resources accessible through the Internet, as well as local resources available using short range communications protocols using, e.g., physical connections (e.g., Ethernet), radio frequency communications (e.g., WiFi), optical communications, (e.g., fiber optics, infrared, or the like), ultrasonic communications, or any combination of these or other media that might be used to carry data between the computing device 710 and other devices. The network interface 716 may, for example, include a router, a modem, a network card, an infrared transceiver, a radio frequency (RF) transceiver, a near field communications interface, a radio-frequency identification (RFID) tag reader, or any other data reading or writing resource or the like.

More generally, the network interface 716 may include any combination of hardware and software suitable for coupling the components of the computing device 710 to other computing or communications resources. By way of example and not limitation, this may include electronics for a wired or wireless Ethernet connection operating according to the IEEE 802.11 standard (or any variation thereof), or any other short or long range wireless networking components or the like. This may include hardware for short range data communications such as Bluetooth or an infrared transceiver, which may be used to couple to other local devices, or to connect to a local area network or the like that is in turn coupled to a data network 702 such as the Internet. This may also or instead include hardware/software for a WiMax connection or a cellular network connection (using, e.g., CDMA, GSM, LTE, or any other suitable protocol or combination of protocols). The network interface 716 may be included as part of the input/output devices 720 or vice-versa.

The data store 718 may be any internal memory store providing a computer-readable medium such as a disk drive, an optical drive, a magnetic drive, a flash drive, or other device capable of providing mass storage for the computing device 710. The data store 718 may store computer readable instructions, data structures, digital models, print instructions, program modules, and other data for the computing device 710 or computer system 700 in a non-volatile form for subsequent retrieval and use. For example, the data store 718 may store without limitation one or more of the operating system, application programs, program data, databases, files, and other program modules or other software objects and the like.

The input/output interface 720 may support input from and output to other devices that might couple to the computing device 710. This may, for example, include serial ports (e.g., RS-232 ports), universal serial bus (USB) ports, optical ports, Ethernet ports, telephone ports, audio jacks, component audio/video inputs, HDMI ports, and so forth, any of which might be used to form wired connections to other local devices. This may also or instead include an infrared interface, RF interface, magnetic card reader, or other input/output system for coupling in a communicating relationship with other local devices. It will be understood that, while the network interface 716 for network communications is described separately from the input/output interface 720 for local device communications, these two interfaces may be the same, or may share functionality, such as where a USB port is used to attach to a WiFi accessory, or where an Ethernet connection is used to couple to a local network attached storage.

A peripheral 722 may include any device used to provide information to or receive information from the computing device 700. This may include human input/output (I/O) devices such as a keyboard, a mouse, a mouse pad, a track ball, a joystick, a microphone, a foot pedal, a camera, a touch screen, a scanner, or other device that might be employed by the user 730 to provide input to the computing device 710. This may also or instead include a display, a speaker, a printer, a projector, a headset or any other audiovisual device for presenting information to a user. The peripheral 722 may also or instead include a digital signal processing device, an actuator, or other device to support control or communication to other devices or components. Other I/O devices suitable for use as a peripheral 722 include haptic devices, three-dimensional rendering systems, augmented-reality displays, magnetic card readers, user interfaces, and so forth. In one aspect, the peripheral 722 may serve as the network interface 716, such as with a USB device configured to provide communications via short range (e.g., BlueTooth, WiFi, Infrared, RF, or the like) or long range (e.g., cellular data or WiMax) communications protocols. In another aspect, the peripheral 722 may provide a device to augment operation of the computing device 710, such as a global positioning system (GPS) device, a security dongle, or the like. In another aspect, the peripheral may be a storage device such as a flash card, USB drive, or other solid state device, or an optical drive, a magnetic drive, a disk drive, or other device or combination of devices suitable for bulk storage. More generally, any device or combination of devices suitable for use with the computing device 700 may be used as a peripheral 722 as contemplated herein.

Other hardware 726 may be incorporated into the computing device 700 such as a co-processor, a digital signal processing system, a math co-processor, a graphics engine, a video driver, and so forth. The other hardware 726 may also or instead include expanded input/output ports, extra memory, additional drives (e.g., a DVD drive or other accessory), and so forth.

A bus 732 or combination of busses may serve as an electromechanical platform for interconnecting components of the computing device 700 such as the processor 712, memory 714, network interface 716, other hardware 726, data store 718, and input/output interface. As shown in the figure, each of the components of the computing device 710 may be interconnected using a system bus 732 or other communication mechanism for communicating information.

Methods and systems described herein can be realized using the processor 712 of the computer system 700 to execute one or more sequences of instructions contained in the memory 714 to perform predetermined tasks. In embodiments, the computing device 700 may be deployed as a number of parallel processors synchronized to execute code together for improved performance, or the computing device 700 may be realized in a virtualized environment where software on a hypervisor or other virtualization management facility emulates components of the computing device 700 as appropriate to reproduce some or all of the functions of a hardware instantiation of the computing device 700.

The above systems, devices, methods, processes, and the like may be realized in hardware, software, or any combination of these suitable for a particular application. The hardware may include a general-purpose computer and/or dedicated computing device. This includes realization in one or more microprocessors, microcontrollers, embedded microcontrollers, programmable digital signal processors or other programmable devices or processing circuitry, along with internal and/or external memory. This may also, or instead, include one or more application specific integrated circuits, programmable gate arrays, programmable array logic components, or any other device or devices that may be configured to process electronic signals. It will further be appreciated that a realization of the processes or devices described above may include computer-executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. In another aspect, the methods may be embodied in systems that perform the steps thereof, and may be distributed across devices in a number of ways. At the same time, processing may be distributed across devices such as the various systems described above, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

Embodiments disclosed herein may include computer program products comprising computer-executable code or computer-usable code that, when executing on one or more computing devices, performs any and/or all of the steps thereof. The code may be stored in a non-transitory fashion in a computer memory, which may be a memory from which the program executes (such as random access memory associated with a processor), or a storage device such as a disk drive, flash memory or any other optical, electromagnetic, magnetic, infrared or other device or combination of devices. In another aspect, any of the systems and methods described above may be embodied in any suitable transmission or propagation medium carrying computer-executable code and/or any inputs or outputs from same.

It will be appreciated that the devices, systems, and methods described above are set forth by way of example and not of limitation. Absent an explicit indication to the contrary, the disclosed steps may be modified, supplemented, omitted, and/or re-ordered without departing from the scope of this disclosure. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context.

The method steps of the implementations described herein are intended to include any suitable method of causing such method steps to be performed, consistent with the patentability of the following claims, unless a different meaning is expressly provided or otherwise clear from the context. So for example performing the step of X includes any suitable method for causing another party such as a remote user, a remote processing resource (e.g., a server or cloud computer) or a machine to perform the step of X. Similarly, performing steps X, Y and Z may include any method of directing or controlling any combination of such other individuals or resources to perform steps X, Y and Z to obtain the benefit of such steps. Thus method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity, and need not be located within a particular jurisdiction.

It should further be appreciated that the methods above are provided by way of example. Absent an explicit indication to the contrary, the disclosed steps may be modified, supplemented, omitted, and/or re-ordered without departing from the scope of this disclosure.

It will be appreciated that the methods and systems described above are set forth by way of example and not of limitation. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context. Thus, while particular embodiments have been shown and described, it will be apparent to those skilled in the art that various changes and modifications in form and details may be made therein without departing from the spirit and scope of this disclosure and are intended to form a part of the invention as defined by the following claims, which are to be interpreted in the broadest sense allowable by law.

What is claimed is:

1. A method comprising:
fabricating a metallic object on a print bed with a three-dimensional printer;
estimating a thermal parameter of the metallic object; and
controlling the three-dimensional printer during fabrication of the object according to the thermal parameter.

2. The method of claim 1, wherein the three-dimensional printer includes a three-dimensional metallic printer configured to additively manufacture the metallic object with a number of droplets of liquefied metal using a metallic liquid expeller.

3. The method of claim 2, wherein the metallic liquid expeller is an electrohydrodynamic expeller configured to drive the droplets of liquefied metal by applying an electrostatic field to a meniscus of the liquefied metal extending from an expeller of the three-dimensional printer.

4. The method of claim 2, wherein controlling the three-dimensional printer includes controlling a mass of the number of droplets.

5. The method of claim 2, wherein controlling the three-dimensional printer includes controlling a velocity of the number of droplets.

6. The method of claim 1, wherein the three-dimensional printer fabricates the metallic object using fused filament fabrication.

7. The method of claim 1, wherein the thermal parameter includes a thermal mass of the metallic object.

8. The method of claim 1, wherein the thermal parameter includes a heat capacity of the metallic object.

9. The method of claim 1, wherein the thermal parameter includes a surface temperature of the metallic object.

10. The method of claim 9, wherein the surface temperature is estimated based on one or more of a shape of the metallic object, a bulk thermal property of a build material used to fabricate the metallic object, and a control signal for one or more of a build chamber temperature or a print bed temperature.

11. The method of claim 9, wherein the surface temperature is estimated based on a thermal measurement of the print bed.

12. The method of claim 1, wherein the thermal parameter includes a thermal resistivity of the metallic object.

13. The method of claim 1, wherein controlling the three-dimensional printer includes controlling a temperature of a build chamber of the three-dimensional printer.

14. The method of claim 1, wherein controlling the three-dimensional printer includes controlling a deposition rate of a metallic build material from an expeller of the three-dimensional printer.

15. The method of claim 1, wherein controlling the three-dimensional printer includes controlling a temperature of the print bed.

16. A computer program product comprising computer executable code embodied in a non-transitory computer-readable medium that, when executing on one or more computing devices in electronic communication with a three-dimensional printer, performs the steps of:
providing instructions for fabricating a metallic object on a print bed with the three-dimensional printer;
estimating a thermal parameter of the metallic object; and
controlling the three-dimensional printer during fabrication of the object according to the thermal parameter.

17. The computer program product of claim 16, wherein the three-dimensional printer includes a three-dimensional metallic printer configured to additively manufacture the metallic object with a number of droplets of liquefied metal using a metallic liquid expeller.

18. The computer program product of claim 17, wherein the metallic liquid expeller is an electrohydrodynamic expeller configured to drive the droplets of liquefied metal by applying an electrostatic field to a meniscus of the liquefied metal extending from an expeller of the three-dimensional printer.

19. An additive manufacturing system including:
a three-dimensional metallic printer configured to additively manufacture a metallic object with a number of droplets of liquefied metal using a metallic liquid expeller; and
a controller in electronic communication with the three-dimensional metallic printer over a data network, the controller including a processor and a memory, the memory bearing computer executable code configured to perform the steps of fabricating the metallic object on a print bed with the three-dimensional metallic printer, estimating a thermal parameter of the metallic object, and controlling the three-dimensional printer during fabrication of the object according to the thermal parameter.

20. The additive manufacturing system of claim 19, wherein the metallic liquid expeller is an electrohydrodynamic expeller configured to drive the droplets of liquefied metal by applying an electrostatic field to a meniscus of the liquefied metal extending from an expeller of the three-dimensional printer.
